(19) United States
(12) Patent Application Publication
(10) Pub. No.: US 2026/0187482 A1
(43) Pub. Date: Jul. 2, 2026

(54) PERFORMANCE-BASED LANGUAGE MODEL ROUTING

(71) Applicant: NVIDIA Corporation, Santa Clara, CA (US)

(72) Inventors: Arun RAMAN, San Jose, CA (US); Paul HENDRICKS, Columbus, OH (US); Rachel OBERMAN, New York, NY (US); Shyam RENJITH, San Clara, CA (US); Aparnaa RAMANI, San Jose, CA (US); Nanthini BALASUBRAMANIAN, San Jose, CA (US); Hirofumi KOBAYASHI, Los Angeles, CA (US); Hai HUANG, Houston, TX (US)

(73) Assignee: NVIDIA Corporation, Santa Clara, CA (US)

(21) Appl. No.: 19/057,808

(22) Filed: Feb. 19, 2025

Related U.S. Application Data
(60) Provisional application No. 63/739,022, filed on Dec. 26, 2024.

(51) Int. Cl. G06N 3/0985

(52) U.S. Cl. CPC G06N 3/0985

(57) ABSTRACT

The present disclosure relates to systems and methods for selecting language models to process queries. A system can process prompts to route the prompts to at least one of a plurality of language models. By using training data including example prompts and example response scores generated by the language models, the system can configure a language model router. The system can provide a prompt to the language model router, which can select a language model based on the prompt, and provide the prompt to the selected language model to generate a response.

### CROSS-REFERENCE TO RELATED PATENT APPLICATIONS

The present application claims priority to U.S. Provisional Ser. No. 63/739,022, filed Dec. 26, 2024, the disclosure of which is incorporated herein by reference in its entirety.

### BACKGROUND

Selecting language models to process prompts presents challenges. Some traditional methods rely on binary classifiers or fixed thresholds to differentiate between two models, leading to inefficiencies and reduced adaptability when routing queries among multiple language models. This approach can result in limited flexibility and scalability, failing to address variations in performance across tasks and subject matter domains. Current systems are inadequate at dynamically adapting to task-specific requirements (e.g., summarization, information retrieval, text generation) and computational constraints, such as latency, throughput, and resource usage, to route queries effectively. Additionally, traditional approaches often rely on static heuristics or simplistic metrics, such as model size, that do not accurately predict performance across diverse tasks or domains, limiting their practicality for complex query-routing scenarios. These challenges in selecting suitable language models create inefficiencies, affecting the accuracy and resource efficiency of query processing for applications (e.g., information retrieval systems, text summarization platforms, and natural language processing pipelines).

### SUMMARY

Implementations of the present disclosure relate to performance-based language model routing. Systems and methods are disclosed that improve query routing to language models by utilizing machine learning-based router models. Systems and methods are disclosed that can include neural network-based routers (e.g., cost optimization BERT, intent classification DeBERTa, and matrix factorization models) and similarity-weighted routing functions to dynamically select language models for processing queries. For example, systems and methods in accordance with the present disclosure can route queries to specific language models based on task-specific performance metrics (e.g., accuracy, latency, similarity, computational cost). Additionally, the disclosed systems and methods can utilize training datasets (e.g., prompt-response datasets and/or query-response datasets) to fine-tune the router models for task-specific query routing. By leveraging machine learning models and similarity-weighting functions, the disclosed systems and methods can improve query-routing efficiency, flexibility, and accuracy. These implementations improve language model selection by providing task-specific query processing for applications such as information retrieval, text generation, and summarization tasks.

Some implementations relate to one or more processors including processing circuitry. The processing circuitry is to provide a prompt to a language model router to cause the language model router to select a language model from a plurality of language models. In some implementations, the language model router is configured based at least on a plurality of example prompts and a plurality of scores of example responses generated by the plurality of language models for the plurality of example prompts. The processing circuitry is to provide the prompt to the selected language model to cause the selected language model to generate a response to the prompt.

In some implementations, the processing circuitry is to select the language model router from a plurality of machine learning (ML) models having varied structures. In some implementations, the processing circuitry is to generate the plurality of scores by providing the plurality of example prompts and plurality of example responses to a language model separate from the plurality of language models. In some implementations, the language model router is to select the language model according to a similarity between the prompt and one or more prompts of the plurality of example prompts and the plurality of scores of the one or more prompts.

In some implementations, the processing circuitry is to select the language model according to a processing cost or cost function associated with generating the response to the prompt using the selected language model. In some implementations, the language model router includes at least one encoder model to classify an intent of the prompt and to select the language model according to the intent. In some implementations, the processing circuitry is to select the language model according to a similarity between at least one vector embedding of the prompt and a plurality of feature embeddings representing one or more functionalities of the plurality of language models. In some implementations, the processing circuitry is to update at least one encoder model of the language model router using a training dataset including prompt-response pairs corresponding with the plurality of example prompts and the plurality of scores of the example responses.

In some implementations, the processing circuitry is to update a configuration file to include information of a plurality of prompts, routing rules, and endpoint addresses of the plurality of language models. In some implementations, responsive to selecting the language model the processing circuitry is to obtain or access the configuration file to determine at least one routing rule and at least one endpoint for processing the prompt by the selected language model. In some implementations, the processing circuitry is to obtain the example responses based at least on transmitting the plurality of example prompts to one or more endpoints corresponding to the plurality of language models. In some implementations, at least one endpoint of the one or more endpoints is associated with a specific language model. In some implementations, responsive to selecting the language model the processing circuitry is to transmit the prompt to a selected endpoint of the selected language model to generate the response.

Some implementations relate to a system including one or more processors. The one or more processors are to receive a query. The one or more processors are to apply the query as input to a language model router to cause the language model router to select a language model from a plurality of language models. In some implementations, the language model router is configured based at least on a plurality of example queries and a plurality of scores of example responses generated by the plurality of language models for the plurality of example queries. The one or more processors are to provide the query to the selected language model to cause the selected language model to generate a response to the query.

In some implementations, the one or more processors are to select the language model router from a plurality of machine learning (ML) models having varied structures. In some implementations, the one or more processors are to generate the plurality of scores by providing the plurality of example queries and plurality of example responses to a language model separate from the plurality of language models. In some implementations, the language model router is to select the language model according to a similarity between the query and one or more queries of the plurality of example queries and the plurality of scores of the one or more queries.

In some implementations, the one or more processors are to select the language model according to a processing cost or cost function associated with generating the response to the query using the selected language model. In some implementations, the language model router includes at least one encoder model to classify an intent of the query and to select the language model according to the intent. In some implementations, the one or more processors are to select the language model according to a similarity between at least one vector embedding of the query and a plurality of feature embeddings representing one or more functionalities of the plurality of language models. In some implementations, the one or more processors are to update at least one encoder model of the language model router using a training dataset including query-response pairs corresponding with the plurality of example queries and the plurality of scores of the example responses.

Some implementations relate to a method. The method includes providing a prompt to a language model router to cause the language model router to select a language model from a plurality of language models. In some implementations, the language model router configured based at least on a plurality of example prompts and a plurality of scores of example responses generated by the plurality of language models for the plurality of example prompts. The method includes providing the prompt to the selected language model to cause the selected language model to generate a response to the prompt.

The processors, systems, and/or methods described herein can be implemented by or included in at least one a system. The system can include a system for performing conversational AI operations. The system can include a system for implementing one or more graphics processing units (GPUs). The system can include a system implementing one or more multi-model language models. The system can include a system implementing one or more large language models (LLMs). The system can include a system implementing one or more small language models (SLMs). The system can include a system implementing one or more vision language models (VLMs). The system can include a control system for an autonomous or semi-autonomous machine. The system can include a perception system for an autonomous or semi-autonomous machine. The system can include a system for performing simulation operations. The system can include a system for performing digital twin operations. The system can include a system for performing light transport simulation. The system can include a system for performing collaborative content creation for 3D assets. The system can include a system for performing deep learning operations. The system can include a system for performing remote operations. The system can include a system for performing real-time streaming. The system can include a system for generating or presenting one or more of augmented reality content, virtual reality content, or mixed reality content. The system can include a system implemented using an edge device. The system can include a system implemented using a robot. The system can include a system for generating synthetic data. The system can include a system for generating synthetic data using AI. The system can include a system incorporating one or more virtual machines (VMs). The system can include a system implemented at least partially in a data center. The system can include a system implemented at least partially using cloud computing resources.

### BRIEF DESCRIPTION OF THE DRAWINGS

The present systems and methods for query modeling and routing are described in detail below with reference to the attached drawing figures, wherein:

FIG. 1 is a block diagram of an example of a system, in accordance with some implementations of the present disclosure;

FIG. 2 is a flow diagram of an example of a method for modeling a prompt to select a language model in a routing pipeline, in accordance with some implementations of the present disclosure;

FIG. 3 is an example illustration of model performance versus cost in selecting language models for processing queries, in accordance with some implementations of the present disclosure;

FIG. 4A is a block diagram of an example generative language model system suitable for use in implementing at least some implementations of the present disclosure;

FIG. 4B is a block diagram of an example generative language model that includes a transformer encoder-decoder suitable for use in implementing at least some implementations of the present disclosure;

FIG. 4C is a block diagram of an example generative language model that includes a decoder-only transformer architecture suitable for use in implementing at least some implementations of the present disclosure;

FIG. 5 is a block diagram of an example computing device suitable for use in implementing at least some implementations of the present disclosure; and

FIG. 6 is a block diagram of an example data center suitable for use in implementing at least some implementations of the present disclosure.

### DETAILED DESCRIPTION

Systems and methods are disclosed related to performance-based language model routing. Language models can vary in how responses that are generated in response to queries perform on a variety of criteria, including but not limited to accuracy, semantic or syntax criteria, latency, throughput, and computational resource usage to generate the responses (which can correspond to a cost assigned to generation of the response and/or a number of tokens used to represent the queries). The performance can also depend on the task represented by the queries (e.g., summarization vs. information retrieval vs. generating lengthy text) and/or the subject matter domain of the queries. Given various such considerations, it can be challenging to select a language model to which to deploy queries in a manner that achieves target performance while avoiding excess computational resource usage.

While some approaches rely on a binary classifier between two possible models, such approaches are not extensible to selecting amongst many different models; for example, they can fail to account for various portions of the model selection solution space in which the performance of models cannot be readily captured with a threshold between two models. For example, the number of parameters of a model is not a sufficiently accurate proxy for the performance of the model on all tasks and domains.

Systems and methods in accordance with the present disclosure can allow for a machine learning-based router model (e.g., router model) to more effectively route a query (e.g., prompt) to a useful language model for generating a response to the query. The system can be sufficiently extensible to route queries to any of three or more language models. The system can include a plurality of router models that can be accessed and/or selected based on user input to allow for greater flexibility in prompt routing. The system can be implemented as a service (e.g., microservice) and/or an interface between a user interface and the plurality of language models. The router model can be configured (e.g., trained, updated, have transfer learning performed, fine-tuned) according to examples of prompts and, in some implementations, scores of example responses generated for the examples of prompts and/or examples of model selections.

For example, a system can provide a prompt to a language model router to cause the language model router to generate a selection of a language model from amongst a plurality of language models. The language model router can be configured based at least on a plurality of example prompts and a plurality of example responses generated by the plurality of language models for the plurality of example prompts. The system can provide the selected language model the prompt to cause the selected language model to generate a response to the prompt. The system can output the response to a device from which the prompt is received.

The system can include multiple language model routers to select the selected language model. For example, the system can include a similarity-weighting function that selects the selected language model based on similarity between the prompt and example prompts for which the selected language model had sufficient and/or high scores. The system can include machine learning model and/or neural network-based routers, such as matrix factorization, cost optimization-based BERT, and/or intent classification encoder (e.g., DeBERTa) routers, which can be updated (e.g., fine-tuned) according to the example prompts, example responses, and/or scores of example responses.

In some examples, the machine learning model(s) (e.g., deep neural networks, language models, LLMs, SLMs, VLMs, multi-modal language models, perception models, tracking models, fusion models, transformer models, diffusion models, encoder-only models, decoder-only models, encoder-decoder models, neural rendering field (NERF) models, diarization models, transcription models, etc.) described herein can be packaged as a microservice-such an inference microservice (e.g., NVIDIA NIMs)-which can include a container (e.g., an operating system (OS)-level virtualization package) that can include an application programming interface (API) layer, a server layer, a runtime layer, and/or a model “engine.” For example, the inference microservice can include the container itself and the model(s) (e.g., weights and biases). In some instances, such as where the machine learning model(s) is small enough (e.g., has a small enough number of parameters), the model(s) can be included within the container itself. In other examples—such as where the model(s) is large-the model(s) can be hosted/stored in the cloud (e.g., in a data center) and/or can be hosted on-premises and/or at the edge (e.g., on a local server or computing device, but outside of the container). In such embodiments, the model(s) can be accessible via one or more APIs—such as REST APIs. As such, and in some embodiments, the machine learning model(s) described herein can be deployed as an inference microservice to accelerate deployment of a model(s) on any cloud, data center, or edge computing system, while ensuring the data is secure. For example, the inference microservice can include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which can include an inference runtime and model optimizations that deliver low latency and high throughput for production applications-such as NVIDIA's TensorRT), and/or enterprise management data for telemetry (e.g., including identity, metrics, health checks, and/or monitoring). The machine learning model(s) described herein can be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice can include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In some embodiments, the inference microservice can include software to perform in-place replacement and/or updating to the machine learning model(s). When replacing or updating, the software that performs the replacement/updating can maintain user configurations of the inference runtime software and enterprise management software.

In some embodiments, the system and methods described herein can be deployed in a talking or smart kiosk application. For example, a kiosk, tablet, smart display, or other device can include one or more onboard processors (e.g., CPUs, GPUs, deep learning accelerators, SoCs) and memory and/or storage (e.g., for storing the model, the image database, etc.). In some embodiments, the kiosk/tablet/display can communicate (e.g., using one or more network interface cards (NICs) and/or data processing units (DPUs)) with one or more locally hosted servers/computing devices and/or with one or more remotely located servers/computing devices (e.g., in one or more data centers). In such examples, the kiosk can communicate with the machine learning model(s) (e.g., language model, LLM, SLM, VLM, MMLM, diffusion model, transformer model, NeRF, DNN, etc.) hosted on the local and/or remote servers using one or more APIs-such as, without limitation, REST APIs.

In one or more embodiments, the system and methods described herein can be deployed in a gaming application. For example, a gaming console, PC, tablet, or other gaming device can include one or more onboard and/or remote processors (e.g., CPUs, GPUs, deep learning accelerators, SoCs) and memory and/or storage (e.g., for storing the game model, game assets, player data, etc.). These devices can use one or more machine learning models (e.g., diffusion models, transformer models, neural rendering field (NeRF) models, language models (e.g., LLMs, VLMs, SLMs, MMLMs, etc.), DNNs, etc.) to enhance gameplay, generate real-time dynamic content, and personalize user experiences based on in-game behavior or pre-stored player profiles. In some embodiments, the system can be deployed in a cloud gaming environment (e.g., NVIDIA's GeFORCE NOW). In such cases, a client device (e.g., a smart display, tablet, or gaming controller) can be used to interact with the game, while the machine learning model(s) and/or visual rendering can occur on one or more remotely located servers/computing devices (e.g., in one or more data centers). The language model, AI processing, and rendering described herein can operate in the cloud, processing player inputs received from an end-user device(s) (e.g., based on controller, keyboard, mouse, joystick, AR/VR/MR/etc. inputs), generating appropriate in-game responses, rendering the content, and sending or transmitting the content to the end-user device(s). During receiving and/or sending the data to and from the end-user or edge device(s), one or more data processing units (DPUs) and/or network interface cards (NICs) can be used.

In some embodiments, the system and methods described herein can be deployed in a video conferencing application. For example, a video conferencing device, such as a dedicated conferencing unit, computer, tablet, and/or smartphone, can include one or more onboard processors (e.g., CPUs, GPUs, deep learning accelerators, SoCs) and memory and/or storage (e.g., for storing the video, audio, or other communication-related data). The system can use the machine learning model(s) (e.g., diffusion models, transformer models, neural rendering field (NeRF) models, language models (e.g., LLMs, SLMs, VLMs, MMLMs, etc.)) to enhance video conferencing functionality, including real-time or near real-time transcription, diarization, language translation, automatic speech recognition (ASR), and/or background noise reduction. In one or more embodiments, the system can enable users to interact with the video conferencing platform using natural language inputs. For example, users can issue voice commands to schedule, join, or leave meetings, or to manage participants and screen sharing. During receiving and/or sending the data to and from the end-user or edge device(s), one or more data processing units (DPUs) and/or network interface cards (NICs) can be used.

In some embodiments, the system and methods described herein can be deployed in a robotics application. For example, a robot or robotic system can include one or more onboard processors (e.g., CPUs, GPUs, hardware-based deep learning accelerators (DLAs), hardware-based programmable vision accelerators (PVAs)-which can include one or more vector processing units (VPUs), direct memory access (DMA) systems, and/or pixel processing engines (PPEs), hardware-based optical flow accelerators (OFAs), SoCs, etc.) and memory and/or storage (e.g., for storing control algorithms, sensor data, and one or more machine learning models). The robotic system can use these processors to execute one or more machine learning models (e.g., language models) that allow it to perform complex tasks autonomously or semi-autonomously, such as interacting with and/or manipulating static and/or dynamic objects, or navigating environments using sensors such as cameras, LiDAR, RADAR, ultrasonic sensors, and more. The system can use sensor fusion techniques to combine data from multiple sensors (e.g., cameras, infrared, LiDAR, RADAR, accelerometers) to create a comprehensive model of the robot's surroundings. This data can be processed locally on the robot or sent to remote servers for more computationally intensive tasks, such as 3D mapping or SLAM (Simultaneous Localization and Mapping). In one or more embodiments, data from individual robots (e.g., sensor data, task status, or environmental conditions) can be uploaded to the cloud, where centralized AI models can analyze and distribute optimized commands to an entire fleet. In some embodiments, the machine learning model(s) (e.g., language models, VLMs, SLMs, LLMs, MMLMs, diffusion models, NeRF models, DNNs, etc.) described herein can be used to allow the robot to perceive and reason about the environment and/or communicate with one or more other robots and/or persons in an environment. In some embodiments, the robot can communicate (e.g., using one or more network interface cards (NICs) and/or data processing units (DPUs)) with one or more locally hosted servers/computing devices and/or with one or more remotely located servers/computing devices (e.g., in one or more data centers).

In some embodiments, the system and methods described herein can be deployed in an in-vehicle infotainment (IVI) system or in-cabin experience (IX) application. For example, the infotainment system within a vehicle (e.g., cars, trucks, drones, construction equipment, robots, semi-autonomous vehicles, or autonomous vehicles) can include one or more onboard processors (e.g., CPUs, GPUs, hardware-based deep learning accelerators (DLAs), hardware-based programmable vision accelerators (PVAs)-which can include one or more vector processing units (VPUs), direct memory access (DMA) systems, and/or pixel processing engines (PPEs), hardware-based optical flow accelerators (OFAs), SoCs, etc.) and memory and/or storage (e.g., for storing control algorithms, sensor data, and one or more machine learning models). and memory and/or storage (e.g., for storing entertainment content, navigation data, and user preferences). The system can use these processors to execute one or more machine learning models (e.g., language models) to enable features such as voice control, personalized media recommendations, dynamic navigation, and real-time communication with other services through network connectivity. The in-vehicle infotainment system can also use natural language processing (NLP) models to enable voice-based interaction. The one or more machine learning models can be stored locally or accessed through one or more APIs that connect to cloud services, enabling the system to process requests in real time or near real-time.

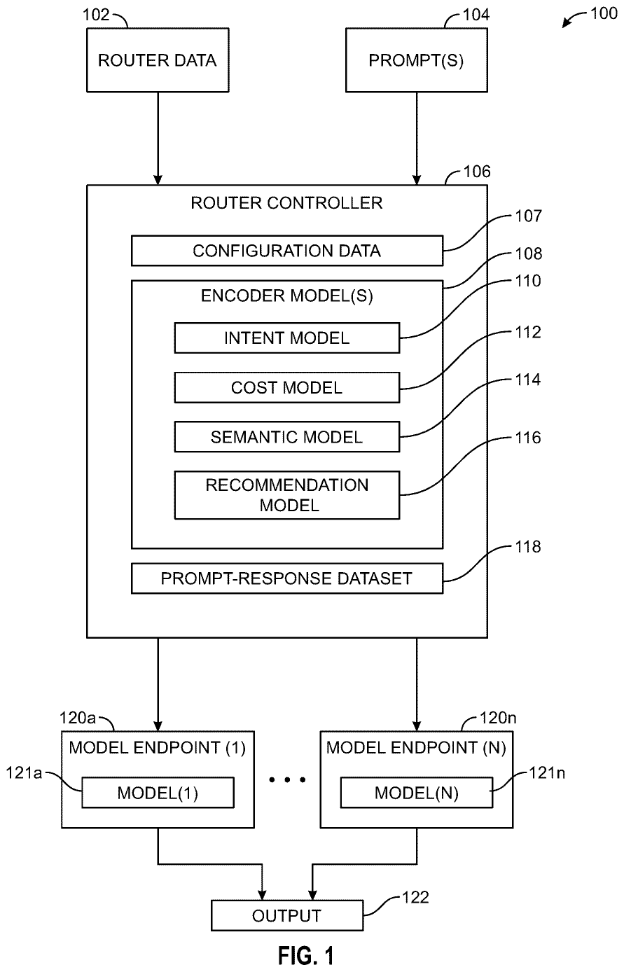

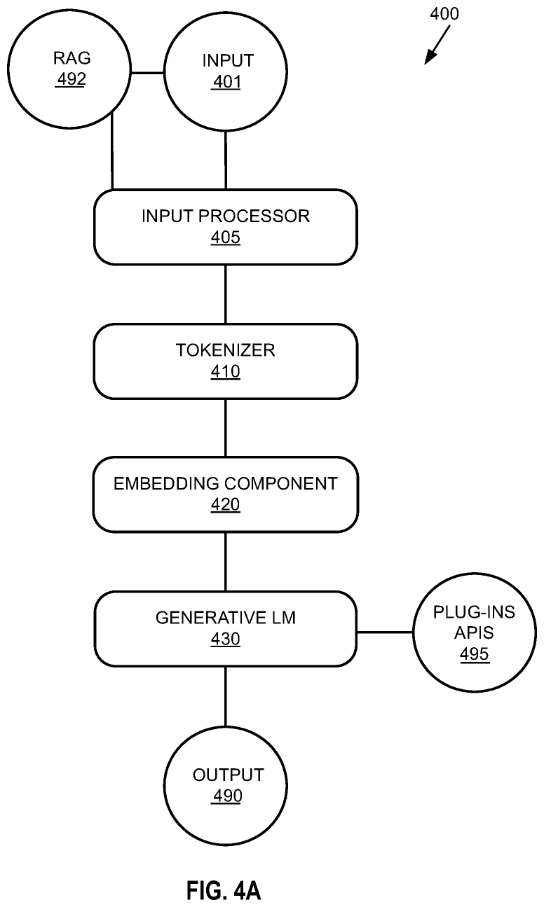

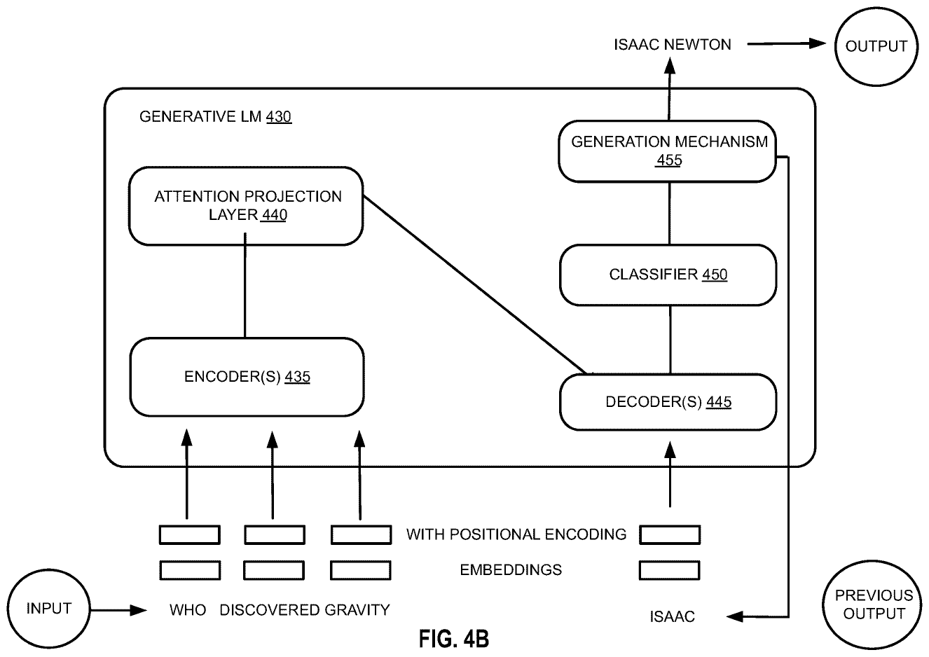

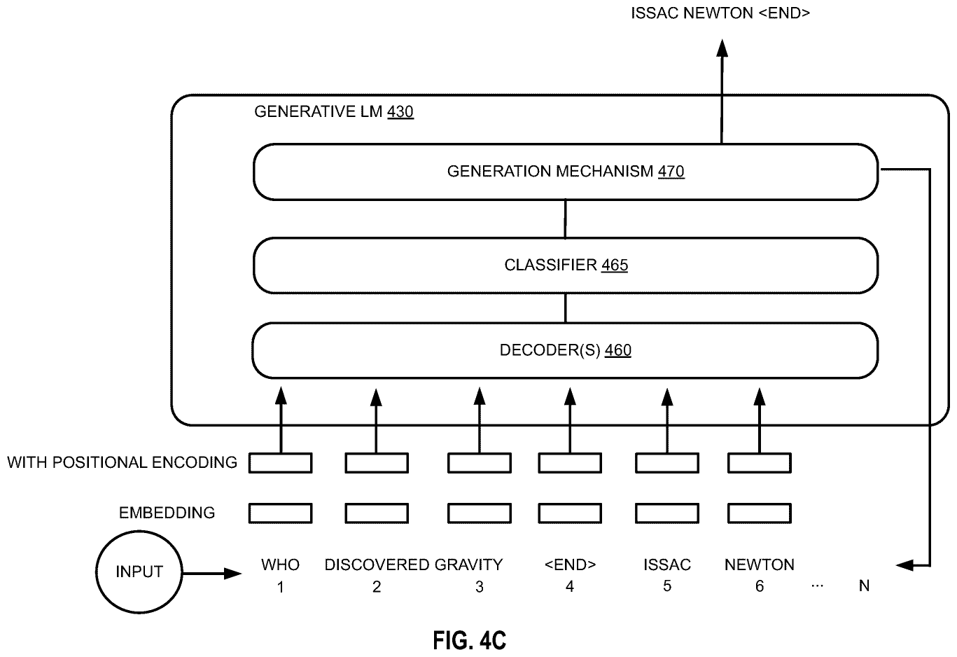

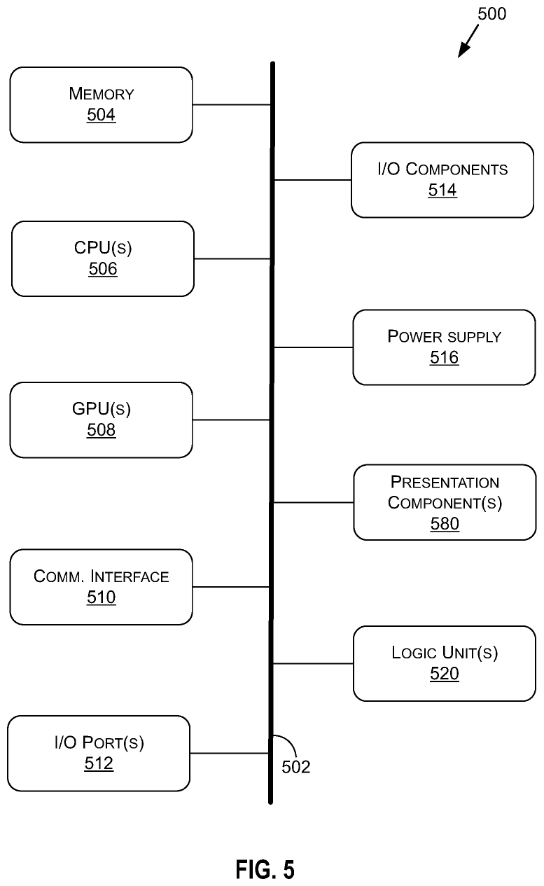

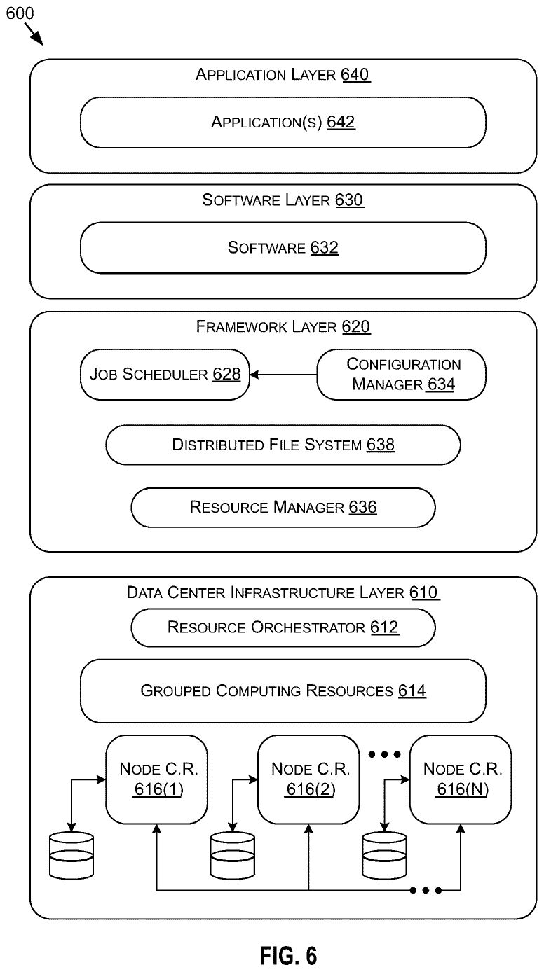

With reference to FIG. 1, FIG. 1 is an example block diagram of a system 100, in accordance with some implementations of the present disclosure. It should be understood that this and other implementations described herein are set forth only as examples. Other implementations and elements (e.g., machines, interfaces, functions, orders, groupings of functions, etc.) can be used in addition to or instead of those shown, and some elements can be omitted altogether. Further, many of the elements described herein are functional entities that can be implemented as discrete or distributed components or in conjunction with other components, and in any combination and location. Various functions described herein as being performed by entities can be carried out by hardware, firmware, and/or software. For example, various functions can be carried out by a processor executing instructions stored in memory. In some implementations, the systems, methods, and processes described herein can be executed using similar components, features, and/or functionality to those of example generative language model system 400 of FIG. 4A, example generative language model (LM) 430 of FIGS. 4B-4C, example computing device 500 of FIG. 5, and/or example data center 600 of FIG. 6.

The system 100 can implement at least a portion of routing pipeline, such as a language processing pipeline, a query routing pipeline, a prompt distribution pipeline. The system 100 can be used to process queries and/or generate responses by any of various systems described herein, including but not limited to customer support systems, e-commerce search systems, educational content delivery systems, healthcare information systems, financial analysis systems, generative AI (GAI) system, and/or conversational AI systems.

Generally, the routing pipeline can include operations performed by the system 100. For example, the routing pipeline can include any one or more of a prompting stage, a prompt routing stage, an endpoint stage. Each stage of the routing pipeline includes one or more components of the system 100 that perform the functions described herein. In some implementations, one or more of the stages can be performed during the training of AI models. Additionally, one or more of the stages can be performed during the inference phase using the AI models.

The system 100 (e.g., implementing the routing pipeline) can provide a prompt (e.g., query) to a language model router to cause the language model router to select a language model from a plurality of language models. That is, the system 100 can be configured and/or otherwise implemented based at least on a plurality of example prompts and a plurality of scores of example responses generated by the plurality of language models for the plurality of example prompts. For example, the system 100 can model the prompt using encoder models to generate routing-related outputs. Additionally, the system 100 can include any one or more of an intent model 110, a cost model 112, a semantic model 114, and/or recommendation model 116. In some implementations, implementing the routing pipeline can include the system 100 providing the prompt to the selected language model to cause the selected language model to generate a response to the prompt. That is, the system 100 can generate routing scores, similarity measures, intent metrics, and/or other recommendations to identify the selected language model. For example, the system 100 can use an encoder or other machine learning-based routers to determine a suitable language model for processing the prompt.

In some implementations, the prompting stage can be the stage in the routing pipeline in which the system 100 can receive and preprocess a query for routing to a language model. The system 100 can include at least one router controller 106. The router controller 106 can receive prompt 104 and/or query from a user. That is, the router controller 106 can process the query to extract features for routing decisions. For example, during the prompting stage, the router controller 106 can generate embeddings or features from the query to assist in selecting a suitable language model. In some implementations, the router controller 106 can receive and/or otherwise obtain the prompt 104 and/or query by receiving input from an external user interface or application. The prompt 104 and/or query can be an input requesting processing by one or more language models. In some implementations, the prompt 104 and/or query can be structured or unstructured text that represents a request for language model processing. That is, the prompt 104 can include content for tasks such as summarization, translation, or text generation. For example, the router controller 106 can verify that the prompt meets required input standards before proceeding to route it.

Additionally, the router controller 106 can receive and/or otherwise obtain router data 102. In some implementations, the router data 102 can include model and/or endpoints for routing, router type information, network addresses for model endpoints (e.g., model endpoint 120a . . . model endpoint 120n, hereafter referred to collectively as “model endpoint(s) 120”), authentication tokens, and/or any configuration data for prompt transmission. For example, the router data 102 can include router type information including model endpoint identifiers, endpoint-specific resource parameters, input formatting requirements, and/or any API specifications for transmitting prompts. That is, the router data 102 can be used by the router controller 106 to send the prompt 104 to the selected model endpoint 120a . . . model endpoint 120n for processing.

In some implementations, the configuration data structure and/or file can be stored in configuration data 107. That is, the router controller 106 can access the router data 102 to retrieve endpoint-specific details to provide and/or otherwise route the prompt 104 to the selected language model. Additionally, the configuration data 107 can be used by the router controller 106 when a model (e.g., model 121a . . . model 121n, hereafter referred to collectively as “language model(s) 121”) is selected by the router controller 106 for routing a prompt 104. For example, the router controller 106 can obtain and/or otherwise access the configuration data 107 to retrieve API keys, endpoint addresses, or formatting specifications associated with the selected model. In this example, the router controller 106 uses the router data 102 to verify the prompt 104 is correctly transmitted to the appropriate language model for processing. In some implementations, the router controller 106 can update the configuration data structures and/or files of the configuration data 107 when new endpoints are added, existing endpoints are modified, or deprecated endpoints are removed. That is, the router controller 106 can maintain the configuration data structures and/or files of the configuration data 107 by updating endpoint information (e.g., upon receipt of new information, upon periodically and/or automatically accessing language models to obtain relevant routing data).

In some implementations, the prompt routing stage can be the stage in the routing pipeline in which the system 100 can process the prompt to determine a language model for generating a response. The system 100 can include the at least one router controller 106. The router controller 106 can provide a prompt 104 to a language model router (e.g., the encoder models 108 including the intent model 110, cost model 112, semantic model 114, and/or recommendation model 116) of the router controller 106 to cause the language model router to select a language model from a plurality of language models (e.g., model 121a . . . model 121n). That is, the language model router can be configured based at least on a plurality of example prompts and a plurality of scores of example responses generated by the plurality of language models for the plurality of example prompts. For example, the router controller 106 can parse and/or otherwise analyze the prompt 104 (e.g., payload) and send the parsed data to at least one language model router (e.g., encoder model(s) 108). In some implementations, the router controller 106 can include encoder models 108, such as any one or more of the intent model 110, cost model 112, semantic model 114, and/or recommendation model 116. That is, during prompt routing stage the router controller 106 can interface with one or more models of the encoder models 108 to process the prompt and calculate metrics for model selection. For example, the router controller 106 can evaluate embeddings, cost scores, or intent classifications to identify a language model suitable for processing the prompt. Additionally, selection of a language model can include analyzing compatibility between the prompt and features associated with available language models.

The router controller 106 can include any one or more artificial intelligence models (e.g., machine learning models, supervised models, neural network models, deep neural network models), rules, heuristics, algorithms, functions, or various combinations thereof to perform operations including processing input prompts for routing, such as analyzing task intent, estimating model costs, or identifying semantic similarities. That is, the router controller can include encoder model(s) 108. In some implementations, the encoder model(s) 108 can be stored in a router model repository and/or data source of the router controller 106 and separate from the router controller 106. The router controller 106 can interface (e.g., using gRPC protocol) with the encoder model(s) 108 via an inference server and/or any other communication mechanism configured to facilitate model interactions. That is, the router controller 106 can store and/or otherwise maintain the inference server such that it can handle prompt processing requests, route data to the encoder model(s), and retrieve outputs efficiently. For example, the inference server can manage multiple encoder models simultaneously, queue requests, or perform load balancing to optimize query processing.

In some implementations, the encoder model(s) 108 can be neural networks and/or machine-learning (ML) models trained to generate feature representations for prompts, including embeddings, cost predictions, and semantic vectors, for routing decisions. In some implementations, the router controller 106 can output routing decisions (e.g., selected language models, task categories, cost estimates, and/or any routing-related outputs). For example, the output can be a selected model endpoint 120 (e.g., model endpoint 120a . . . model endpoint 120n). In another example, the output can be a prioritized list of candidate models ranked by suitability (e.g., task compatibility, resource requirements, and performance metrics). In this example, the router controller 106 can generate rankings based on prompt characteristics and model evaluation scores derived from prior routing tasks. In some implementations, the prompt-response dataset 118 (also referred to herein as “query-response dataset”) can be provided to the router controller 106 to perform training, updating, fine-tuning, and periodic updates to the encoder model(s) 108 (e.g., stored in a router model repository and/or accessed via an inference server using a gRPC protocol).

In some implementations, the router controller 106 can maintain, execute, train, update, and/or otherwise process, refile, or apply one or more artificial intelligence (AI) models during the prompt routing stage. In some implementations, the AI model(s) can include any type of encoder model(s) 108 capable of processing input prompts to generate task-specific outputs (e.g., semantic embeddings, cost estimations, intent determinations) to identify the language model for processing the input (e.g., the model that produces outputs consistent with task-specific requirements and/or predefined evaluation metrics). For example, the AI model(s) can be trained and/or updated to classify prompt intent, estimate model costs, and/or compute semantic similarities, among other tasks.

In some implementations, the AI model(s) can be or include an intent model 110 (e.g., intent classification DeBERTa), a cost model 112 (e.g., cost optimization bidirectional encoder representations from transformers (BERT)), a semantic model 114 (e.g., sentence BERT), a recommendation model 116 (e.g., matrix factorization model), any transformer-based model (e.g., a generative pre-trained transformer (GPT) model), and/or any large language model (LLM). For example, the intent model 110 can be trained and/or implemented to classify a prompt based on task type (e.g., summarization, information retrieval, translation, question answering, content generation, and/or any natural language processing tasks). In another example, the cost model 112 can be trained and/or implemented to calculate numerical scores for computational requirements (e.g., memory, processing time) for specific model endpoints 120 based on prompt characteristics. In another example, the cost model 112 can be trained and/or implemented to assign cost-related scores to routing endpoints by aggregating resource usage metrics derived from previous task executions. In yet another example, the semantic model 114 can be trained and/or implemented to generate vector embeddings that encode semantic features of input prompts for comparison with endpoint capabilities. In yet another example, the recommendation model 116 can be trained and/or implemented to rank routing endpoints based on similarity scores between input prompts and historical prompt-response and/or query-response data.

Generally, the fine-tuning and/or updating of the encoder models 108 can include updating model parameters (e.g., weights, biases) based on labeled data to improve task-specific routing performance. That is, the prompt-response dataset 118 including prompt and response pairs with corresponding scores can be used as training data to improve the encoder models 108 for specific tasks, such as intent classification, cost estimation, or semantic similarity evaluation. For example, the router controller 106 can fine-tune at least one of the encoder models 108 by using gradient-based methods to reduce the loss between predicted routing decisions and target outcomes in the prompt-response dataset 118. In this example, the router controller 106 performs fine-tuning by iteratively updating model parameters based on calculated loss functions using prompt-response and/or query-response pairs.

In some implementations, the router controller 106 can execute the encoder model(s) 108 to generate routing-related outputs (e.g., an endpoint selection, a plurality of scores, and/or any ranked lists of candidate models). Generally, the execution of the encoder model(s) 108 can be facilitated via an inference server (e.g., locally or remote) that can maintain a router model repository. That is, the prompt 104 and/or additional context such as model information of models 120 (e.g., metrics, response latency, computational resource usage, accuracy scores, and/or any task compatibility information) can be provided to at least one encoder model 108. The router controller 106 can receive data to provide as input to the encoder model(s) 108, which can include prompts 104, task-specific labels, training metrics (e.g., prompt-response dataset 118 including a plurality of example prompts and a plurality of scores of example responses), and/or any routing-related constraints.

Generally, the router controller 106 can select one or more encoder models 108 to model the prompt 104. In some implementations, the selection of the one or more encoder models 108 can be selected based on a user preference and/or parameter (e.g., preferred latency thresholds, specific task requirements, domain-specific model selection, resource usage constraints, and/or any custom model ranking rules). For example, the router controller 106 can prioritize when a user specifies a preference for low-latency responses. In another example, the router controller 106 can prioritize when a user selects models optimized for specific domains, such as medical or legal text processing. The selection of the encoder model 108 can be based at least on task type, input format, required accuracy, the application, latency requirements, user preference or user configuration, and/or any cost-related constraints. That is, the router controller 106 can evaluate various factors to dynamically select at least one suitable encoder model 108 for routing the prompt. Additionally, the router controller 106 can select the encoder model 108 and/or encoder models 108 based on user-defined configuration files or runtime parameter adjustments. For example, users can define a weighted preference where higher priority is assigned to latency over running cost by setting a parameter or scale value, such as configuring a latency-to-cost ratio in the router controller 106 to favor low-latency models despite higher computational expenses. In this example, users can adjust a configuration parameter in the router controller 106 to prioritize latency over running cost, facilitating the selection of an encoder model 108 for faster response times even if the encoder model 108 requires higher computational resources.

For example, the intent model 110 can be selected to determine a model for routing when the prompt 104 includes indicators of specific task types or intent (e.g., translation, summarization) and/or when a user preference and/or parameter indicates a priority for handling task-specific or context-sensitive queries. In another example, the cost model 112 can be selected to determine a model for routing when the prompt 104 relates to minimizing resource usage or computational costs and/or when a user prioritizes the minimization of resource usage and/or computational cost. In this example, the prompt 104 can relate to minimizing resource usage or computational costs when it specifies low-complexity tasks (e.g., basic information retrieval) or includes metadata indicating constraints on latency or token usage. In yet another example, the semantic model 114 can be selected to determine a model for routing when the prompt 104 relates to evaluating semantic similarity to predefined examples or historical data. In this example, the prompt 104 can relate to evaluating semantic similarity when it includes phrasing or terminology associated with prior queries stored in the system 100 or explicitly references known data structures or contexts. In yet another example, the recommendation model 116 can be selected to determine a model for routing when the prompt 104 relates to ranking of multiple candidate models based on prior performance or compatibility. In this example, the prompt 104 can relate to ranking of multiple candidate models when it includes ambiguous or broad task descriptions requiring multiple candidate evaluations to identify the most effective language model.

While various encoder models 108 are described herein, it should be understood that the disclosure should not be limited to particular encoder models 108 described and/or corresponding implementations. Thus, it should be understood that alternative encoder models 108 and/or other non-encoder models can also be applied based on the application and/or task requirements. Additionally, while an inference server and router model repository is described herein as components for managing and executing routing and inference tasks, it should be understood that these components can be implemented in a distributed manner, integrated into a unified system, or replaced with equivalent architectures based on system design and performance considerations.

Additionally, two or more encoder models 108 can be selected when multiple routing factors need to be evaluated (e.g., intent classification and cost estimation). For example, the intent model 110 and the cost model 112 can be selected to determine a model for routing the prompt 104 when the prompt 104 involves a task relating to both accuracy and cost minimization. In this example, the task can relate to both accuracy and cost minimization when the prompt 104 includes tasks requiring detailed output but constrained by specific resource limits (e.g., it includes metadata specifying resource constraints (e.g., latency thresholds, token limits) or task descriptors indicating resource sensitivity (e.g., quick response or low-power mode)). That is, the router controller 106 can combine outputs from multiple encoder models to improve routing decisions.

In some implementations, when multiple encoder models 108 are selected, the router controller 106 can analyze the response from the encoder models 108 by aggregating or weighting outputs based on predefined criteria (e.g., routing confidence scores, resource efficiency scores, semantic relevance scores). For example, the router controller 106 can combine intent classification scores with cost estimates to select a suitable language model. In this example, the language model selected (e.g., model 121a . . . model 121n) can be based on a weighted ranking of model compatibility with the prompt 104 and cost constraints. In another example, the router controller 106 can resolve conflicting outputs from multiple encoder models 108 by applying priority rules. In this example, the language model 121 selected (e.g., model 121a . . . model 121n) can be based on the encoder model 108 output with the highest priority for the given task.

In some implementations, during inference, the intent model 110, operated by the router controller 106, can classify the prompt 104 into predefined task categories such as summarization, translation, or question answering. That is, the intent model 110 can be used to select the language model 121 based on classifying an intent of the prompt 104 and to select the language model 121 according to the intent. For example, the intent model 110 can receive a prompt 104 which can be a question, a command, or a descriptive statement. In this example, a language model 121 can be selected based on the task category assigned to the prompt 104 (e.g., selecting a summarization model for a descriptive statement or a QA model for a question).

In some implementations, during inference, the cost model 112, operated by the router controller 106, can analyze the prompt 104 to estimate the resource usage required to generate a response, including processing time, memory usage, or token count. That is, the cost model can be used to select the language model 121 according to a processing cost associated with generating the response to the prompt 104 using the selected language model 121. For example, the cost model 112 can receive a prompt 104 which can be a computationally simple query or a resource-intensive request (e.g., a single-sentence query versus a request for generating a lengthy document). In this example, a language model 121 can be selected based on the estimated cost associated with processing the prompt 104 using different models (e.g., selecting a lightweight model for simple queries).

In some implementations, during inference, the semantic model 114, operated by the router controller 106, can generate vector embeddings of the prompt 104 and compare them with stored embeddings representing the capabilities or features of different language models 121. For example, the vector embeddings can be representations of semantic characteristics of the prompt, such as contextual meaning, task type, or domain relevance. That is, the vector embeddings can be numerical encodings capturing relationships between the text of the prompt 104 and predefined task-specific or domain-specific features. Additionally, the semantic model 114 can select the language model 121 according to a similarity between at least one vector embedding of the prompt 104 and a plurality of feature embeddings representing one or more functionalities of the plurality of language models 121. For example, the feature embeddings can be representations of model-specific characteristics such as supported task types, domain expertise, and/or historical performance metrics. That is, the feature embeddings can be numerical representations capturing information about the capability of the language model 121 to process specific types of queries, such as summarization, question answering, or domain-specific text processing. For example, the semantic model 114 can receive a prompt 104 which can be text with domain-specific terminology or references (e.g., medical terms or computer science phrasing). In this example, a language model 121 can be selected based on the similarity score between the embedding of the prompt 104 and embeddings associated with the language models 121 fine-tuned for specific domains.

In some implementations, during inference, the recommendation model 116, operated by the router controller 106, can rank available language models 121 based on prior performance metrics or historical prompt-response data. That is, the recommendation model 116 can select the language model 121 according to a similarity between the prompt 104 and one or more prompts of the plurality of example prompts and the plurality of scores of the one or more prompts (e.g., historical prompt-response data and/or evaluation metrics). For example, the recommendation model 116 can receive a prompt 104 which can be a query similar to previously processed prompts stored in the system (e.g., asking for a summary or a factual response). In this example, a language model 121 can be selected based on its historical performance score for prompts matching the current query.

In some implementations, the similarity between the prompt and one or more prompts of the plurality of example prompts and the plurality of scores of the one or more prompts can be determined using scoring functions, factor modeling, and/or learned representations. That is, the router controller 106 can apply a similarity-weighted algorithm (e.g., cosine similarity, Euclidean distance, and/or any function-based similarity metric) to compare the prompt 104 with historical prompts associated with known response scores to determine a suitable language model 121. In some implementations, the router controller 106 can utilize matrix factorization (e.g., singular value decomposition (SVD), singular value decomposition (SVD), probabilistic matrix factorization (PMF)) to model latent relationships (e.g., weighting functions based on historical selection patterns, statistical decomposition of prompt-response associations, multi-dimensional embedding projections, structured relationship extraction, and/or any factorization-based representation learning) between prompts and response scores, identifying implicit similarities to facilitate model selection. That is, a matrix factorization router can be implemented. Additionally, the router controller 106 can implement a fine-tuned LLM-based router that processes the prompt 104 using embeddings and/or contextual relationships learned from example prompt-response pairs. In some implementations, the similarity can be determined by applying weighted functions to similarity metrics, ranking candidate language models 121 according to computed similarity scores. For example, the router controller 106 can assign selection probabilities to different language models 121 based on aggregated similarity measures across multiple routing approaches.

In some implementations, the router controller 106 can execute one or more AI models (e.g., encoder model(s) 108) by utilizing a distributed training and tuning framework to improve the performance of the AI model during the fine-tuning and inference phases. The framework can include implementing techniques such as gradient descent, backpropagation, and distributed training to process large-scale datasets like prompt-response dataset 118 (e.g., training data). The AI model(s) can incorporate mechanisms such as dropout regularization and weight pruning to maintain efficiency and prevent overfitting. For example, during execution, the router controller 106 can partition input data into mini-batches, apply loss functions, and update model parameters iteratively. The encoder model(s) 108 can support inference operations that include processing feature vectors, transforming raw input data, and generating probabilistic predictions and/or routing metrics. The router controller 106 can integrate hardware accelerators such as GPUs or TPUs to handle computational demands for training and inference, for example, when processing a high volume of routing tasks in real-time.

In some implementations, the router controller 106 can include at least one AI model (e.g., encoder model(s) 108). The encoder model(s) 108 can include an input layer, an output layer, and/or one or more intermediate layers (e.g., encoder layers, transformer layers), such as hidden layers, which can each have respective nodes. That is, the encoder model(s) 108 process inputs using multi-layer architectures for generating routing-related features. For example, the input layer processes raw prompt data or embeddings. For example, the output layer generates routing-specific outputs such as endpoint selections, task classifications, and/or model recommendations. For example, the intermediate layers determine semantic features, cost estimates, or intent probabilities. That is, the intermediate layers and/or output layer can be stacked encoder layers that can generate hierarchical feature representations from input prompts for routing decisions. For example, the BERT (e.g., cost model 112) can include attention mechanisms that can calculate weights for individual tokens in the input to determine relevance for cost estimation tasks. In another example, DeBERTa (e.g., intent model 110) can include disentangled attention heads that can separate semantic and syntactic features to classify task intent with higher precision.

In some implementations, the router controller 106 can configure (e.g., train, update, fine-tune, apply transfer learning to) the encoder model(s) 108 by modifying or updating one or more parameters, such as weights and/or biases, of various nodes of the encoder model(s) 108 responsive to evaluating estimated outputs of the encoder model(s) 108 (e.g., generated in response to receiving training examples in a training dataset, such as prompt-response dataset 118). The router controller 106 can be or include various neural network models, including models that can generate data representations such as embeddings, cost predictions, task labels, and/or various combinations thereof.

In some implementations, the prompt-response dataset 118 can include prompt-response pairs (e.g., prompt, response) corresponding to task types, computational cost estimates, semantic representations, or routing recommendations derived from model outputs. That is, the router controller 106 can perform fine-tuning of the intent model 110, cost model 112, semantic model 114 (e.g., in some implementations, the semantic model 114 can rely on pre-computed similarity metrics and measures such that fine-tuning is not performed), and/or recommendation model 116 using the prompt-response dataset 118. Fine-tuning can be used to update model parameters, including weights and biases, for example, by reducing loss functions calculated between predicted outputs and target labels derived from the dataset.

In some implementations, the router controller 106 can identify and/or otherwise specify prompts and corresponding endpoints in the configuration data 107 (e.g., configuration files). That is, the configuration data 107 can be generated and/or otherwise created when new routing rules or new model endpoints 120 are identified (e.g., the model endpoints 120 that meet specified task or routing criteria) and/or otherwise registered by the system 100. The configuration data 107 can store mappings between prompts and endpoints, default routing thresholds, and scoring metrics for model evaluation. The router controller 106 can generate the configuration data 107 to facilitate alignment between prompts and the task-specific capabilities of the model endpoints 120. For example, the router controller 106 can specify associations between prompts and endpoints based on task categories, model capabilities, and/or routing constraints. Additionally, the router controller 106 can update the configuration data 107 when routing requirements change or the model endpoints 120 are added, modified, or deprecated. For example, the router controller 106 can adjust endpoint mappings, update scoring thresholds, or redefine task-specific prompts to reflect changes in model performance or system requirements. The router controller 106 can interface and/or otherwise interact with model endpoints 120 (e.g., Llama3-8B, Llama3-70B, Mixtral 8x22B, GPT-4, and/or any language models) to generate responses to predefined prompts. Generated prompt-response pairs can be stored in the prompt-response dataset 118.

For example, to fine-tune the intent model 110 the router controller 106 can update parameters to improve task classification performance based on labeled examples in the prompt-response dataset 118. In another example, to fine-tune the cost model 112 the router controller 106 can update model parameters to predict computational resource scores for at least one (e.g., each) routing endpoint. In yet another example, to fine-tune the recommendation model 116 the router controller 106 can update model parameters to associate prompts with evaluation scores generated by different routing endpoints. In yet another example, to fine-tune the semantic model 114 the router controller 106 can update model parameters to generate embeddings for routing.

In some implementations, training data (e.g., prompts and/or responses) can be preprocessed to generate consistent input formats for use with the encoder model(s) 108 of the router controller 106. For example, prompts can be normalized to remove inconsistencies, and responses can be encoded into structured formats suitable for training. Additionally, the router controller 106 can perform preprocessing by identifying and filtering data that does not satisfy or meet predefined quality thresholds (e.g., incomplete data, responses with low relevance scores, and/or outputs containing formatting errors) based on metrics (e.g., semantic consistency, response accuracy, and/or structural validity). The preprocessed data can be used to adjust parameters (e.g., weights and/or biases) of the encoder model(s) 108 using iterative updates based on differences between model outputs and expected values. For example, gradients can be computed from a loss function representing discrepancies between the outputs of the encoder model(s) 108 and training data, and the parameters of the encoder model(s) 108 can be updated to reduce these discrepancies. The encoder model(s) 108 can be evaluated using metrics such as classification accuracy, cost prediction error, or comparison of recommendations with example outputs to determine performance and suitability for deployment.

Additionally, the router controller 106 can generate and store the prompt-response dataset 118 by interfacing with model endpoints 120 to collect responses corresponding to a set of prompts. That is, the set of prompts can be data of universal prompts and/or unique prompts (e.g., Mistral 8x22B, LlaMa 3.1 8B) to at least one encoder model 108. The responses can be scored and/or otherwise evaluated by the router controller 106 (e.g., using a reward model and/or any scoring criteria). Scoring of the responses can include measuring response accuracy, fluency, relevance, and/or compliance with task-specific objectives. That is, the router controller 106 can analyze the generated responses against target outputs or evaluation metrics to assign a numerical score. For example, at least one response of a corresponding prompt can be scored by calculating a similarity score between the response and a predefined ground truth output. In another example, at least one response of a corresponding prompt can be scored by assessing response quality based on probabilistic metrics generated by a reward model. The prompt-response dataset 118 can be generated for at least one (e.g., each) of the language models 121, such that at least one language model 121 can include prompt-response pairs including a prompt and a corresponding scored response.

In some implementations, the prompt-response dataset 118 can be built and/or otherwise generated by executing a data generation process that iterates over a range of task-specific prompts and/or any variations of prompts (e.g., paraphrased prompts, modified input structures), and the router controller 106 can score and/or record the outputs of different language models 121 in the prompt-response dataset 118. For example, the router controller 106 can generate and transmit one or more prompts to the model endpoints 120 (e.g., of various language models 121). One or more of the language models 121 can provide (e.g., via the model endpoints 120) a response that can be evaluated for alignment with predefined task requirements, scoring and/or quality criteria. For example, the response can be scored by calculating its similarity to a ground truth response using various metrics such as BLEU, ROUGE, and/or cosine similarity. In this example, the response can be given a numerical value (e.g., score) where a higher score represents better alignment with predefined requirements, such as accuracy, fluency, and/or relevance, and a lower score indicates deviations or inconsistencies.

In some implementations, the router controller 106 can log metadata (e.g., in the prompt-response dataset 118) corresponding with the generated responses, including scores, model identification, inference time, and confidence scores. In some implementations, during prompt-response dataset 118 generation, the router controller 106 can rank the collected responses by performing scoring (e.g., semantic relevance, task accuracy, and/or response score and/or quality) and/or facilitating human-in-the-loop annotations to validate response correctness. Additionally, the router controller 106 can implement filtering mechanisms to exclude low-quality responses (e.g., responses with low confidence scores or high error rates) and/or irrelevant responses (e.g., responses that do not meet the task-specific prompt intent) from the prompt-response dataset 118 (e.g., responses from the language models 121).

In some implementations, the router controller 106 can be configured (e.g., trained, updated, fine-tuned, has transfer learning performed, etc.) based at least on the training data of the at least one training dataset (e.g., prompt-response dataset 118 including, but not limited to, task-specific labeled data, domain-specific prompts, generated response scores, and/or historical routing data). For example, one or more example prompts and/or responses and corresponding scores of the training data can be applied (e.g., by the system 100, or in a pre-training process performed by the system 100 or another system) as input to the encoder model(s) 108 to cause the encoder model(s) 108 to generate an estimated output. The estimated output can be evaluated and/or compared with ground truth routing labels (or expected routing outcomes) of the training data that correspond with the one or more example prompts and/or responses, and the encoder model(s) 108 of the router controller 106 can be updated based at least on the error metric and/or feedback adjustments. For example, based at least on an output of routing scores or embeddings, one or more parameters (e.g., weights and/or biases) of the encoder model(s) 108 of the router controller 106 can be updated.

In some implementations, the endpoint stage can be the stage in the routing pipeline in which the system 100 can send the prompt to the selected model endpoint 120 and retrieve the generated response. The system 100 can include at least one router controller 106, at least one model endpoint 120, and at least one language model 121. The router controller 106 can provide the prompt 104 to the selected language model (e.g., via the model endpoint 120) to cause the selected language model (e.g., language model 121) to generate a response (e.g., output 122) to the prompt 104. That is, the router controller 106 can transmit the prompt to the model endpoint 120 and facilitate communication for response retrieval. For example, during the endpoint stage, the router controller 106 can route the prompt to a specific model endpoint 120 based on routing decisions and retrieve and/or otherwise obtain the response generated by the language model 121. In some implementations, the model endpoints 120 can be interfaces that facilitate communication between the router controller 106 and the language models 121. That is, the router controller 106 can interface with the language models 121 via the model endpoints 120. For example, a first model endpoint 120 can be configured for low-latency processing, and a second model endpoint 120 can be configured for handling large inputs.

While the model endpoints 120 are described as being interfaces for routing prompts to language models 121, it should be understood other endpoints can also be selected based on the output of the language model router. That is, the router controller 106 can use the classification or output of the router to route the prompt to non-language model endpoints, such as hardware accelerators (e.g., selecting a specific GPU type) or task-specific services (e.g., triggering predefined actions or workflows). For example, the router controller 106 can classify a prompt and route it to a fine-tuned GPU for high-computation tasks or to a low-power GPU for resource-constrained environments. In another example, the router controller 106 can classify a prompt as requiring action-specific processing and route it to a predefined action endpoint, such as initiating a database query or invoking a microservice for content generation.

Additionally, the router controller 106 can format the transmission and/or data payload provided to the model endpoints 120 according to the configuration data 107. For example, the router controller 106 can adjust data formatting, add required parameters, or include authentication details as specified in the configuration data 107. Additionally, the selected language model 121 can model the prompt 104 by executing the operations to generate a response to the input prompt. The language model 121 can provide an output 122 (e.g., response) that can be provided to the router controller 106 for presentation and/or transmission back to a user device or another system. In some implementations, the output 122 can be a structured response, raw text, or data in a specified format (e.g., JSON, XML). That is, the router controller 106 can receive and/or otherwise obtain the output 122 from the language model 121 by establishing communication with the model endpoint 120 and retrieving the processed response data. For example, the router controller 106 can receive the output 122 via an HTTP API call or a socket connection to the model endpoint 120. In some implementations, to provide the output 122 to a user and/or another system or application, the router controller 106 can reformat or annotate the output based on the requirements of the user or system. For example, the router controller 106 can convert the raw response into a user-readable format or incorporate it into a workflow-specific data structure for downstream use.

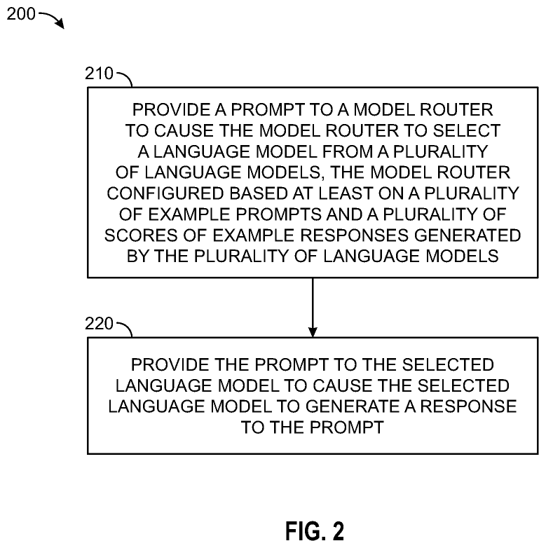

With reference to FIG. 2, an example flow diagram illustrating method for modeling a prompt to select a language model in a routing pipeline, in accordance with some implementations of the present disclosure. It should be understood that this and other implementations described herein are set forth only as examples. Other implementations and elements (e.g., machines, interfaces, functions, orders, groupings of functions, etc.) can be used in addition to or instead of those shown, and some elements can be omitted altogether. Further, many of the elements described herein are functional entities that can be implemented as discrete or distributed components or in conjunction with other components, and in any combination and location. Various functions described herein as being performed by entities can be carried out by hardware, firmware, and/or software. For example, various functions can be carried out using one or more processor executing instructions stored in one or more memories. For example, in some implementations, the system and methods described herein can be implemented using one or more generative language models (e.g., as described in FIGS. 4A-4C), one or more computing devices or components thereof (e.g., as described in FIG. 5), and/or one or more data centers or components thereof (e.g., as described in FIG. 6).

Now referring to FIG. 2, each block of method 200, described herein, includes a computing process that can be performed using any combination of hardware, firmware, and/or software. For example, various functions can be carried out using one or more processors executing instructions stored in one or more memories. The method can also be embodied as computer-usable instructions stored on computer storage media. The method can be provided by a standalone application, a service or hosted service (standalone or in combination with another hosted service), as a microservice via an application programming interface (API) or a plug-in to another product, to name a few. In addition, method 200 is described, by way of example, with respect to the system of FIG. 1. However, this method can additionally or alternatively be executed by any one system, or any combination of systems, including, but not limited to, those described herein.

FIG. 2 is a flow diagram showing a method 200 for providing, applying, and/or providing operations, in accordance with some implementations of the present disclosure. Various operations of method 200 can relate to improving the efficiency and accuracy of query routing and response generation using language models. Existing systems often rely on and/or use static routing mechanisms or limited binary classifiers, which can lead to inefficiencies and reduced adaptability when handling diverse query types. The existing technological problems can arise when these systems fail to dynamically adapt to task-specific requirements or resource constraints, resulting in suboptimal performance or excessive resource usage. Method 200 of FIG. 2 can solve these technological problems by implementing a machine learning-based router to dynamically model (e.g., evaluate, analyze) and route queries to language models, thereby improving scalability, flexibility, and resource allocation in query processing.

The systems and methods described herein can be used for a variety of purposes, by way of example and without limitation, for machine (e.g., robot, vehicle, construction machinery, warehouse vehicles/machines, autonomous, semi-autonomous, and/or other machine types) control, machine locomotion, machine driving, synthetic data generation, model training (e.g., using real, augmented, and/or synthetic data, such as synthetic data generated using a simulation platform or system, synthetic data generation techniques such as but not limited to those described herein, etc.), perception, augmented reality (AR), virtual reality (VR), mixed reality (MR), robotics, security and surveillance (e.g., in a smart cities implementation), autonomous or semi-autonomous machine applications, deep learning, environment simulation, object or actor simulation and/or digital twinning, data center processing, conversational AI, light transport simulation (e.g., ray-tracing, path tracing, etc.), distributed or collaborative content creation for 3D assets (e.g., using universal scene descriptor (USD) data, such as OpenUSD, and/or other data types), cloud computing, generative artificial intelligence (e.g., using one or more diffusion models, transformer models, etc.), and/or any other suitable applications.

Disclosed implementations can be comprised in a variety of different systems such as automotive systems (e.g., a control system for an autonomous or semi-autonomous machine, a perception system for an autonomous or semi-autonomous machine), systems implemented using a robot or robotic platform, aerial systems, medial systems, boating systems, smart area monitoring systems, systems for performing deep learning operations, systems for performing simulation operations (e.g., in a driving or vehicle simulation, in a robotics simulation, in a smart cities or surveillance simulation, etc.), systems for performing digital twin operations (e.g., in conjunction with a collaborative content creation platform or system, such as, without limitation, NVIDIA's OMNIVERSE and/or another platform, system, or service that uses USD or OpenUSD data types), systems implemented using an edge device, systems incorporating one or more virtual machines (VMs), systems for performing synthetic data generation operations (e.g., using one or more neural rendering fields (NERFs), gaussian splat techniques, diffusion models, transformer models, etc.), systems implemented at least partially in a data center, systems for performing conversational AI operations, systems implementing one or more language models-such as one or more large language models (LLMs), one or more vision language models (VLMs), one or more multi-modal language models, etc., systems for performing light transport simulation, systems for performing collaborative content creation for 3D assets (e.g., using universal scene descriptor (USD) data, such as OpenUSD, computer aided design (CAD) data, 2D and/or 3D graphics or design data, and/or other data types), systems implemented at least partially using cloud computing resources, and/or other types of systems.

The method 200, at block 210, includes providing a prompt (e.g., query submitted by a user) to a language model router to cause the language model router to select a language model from a plurality of language models. That is, the language model router configured based at least on a plurality of example prompts and a plurality of scores of example responses generated by the plurality of language models for the plurality of example prompts. The language model router can include one or more AI model(s). The AI model(s) can be or include an intent model (e.g., intent classification DeBERTa), a cost model (e.g., cost optimization bidirectional encoder representations from transformers (BERT)), a semantic model (e.g., sentence BERT), a recommendation model (e.g., matrix factorization model), any transformer-based model (e.g., a generative pre-trained transformer (GPT) model), and/or any encoder-based model. In some implementations, the AI model(s) can be accessed and/or otherwise maintained in a router model repository (e.g., a local or remote inference server, cloud-based storage, on-premises hardware, distributed systems). That is, the processing circuits can retrieve model configurations, training data, or updated parameters for inference tasks. For example, the processing circuits can access the repository to load or execute the AI models.

In some implementations, the processing circuits (e.g., processing circuitry) can select the language model router from a plurality of machine learning (ML) models having varied structures. In some implementations, the processing circuits can generate the plurality of scores by providing the plurality of example prompts and plurality of example responses to a language model separate from the plurality of language models (e.g., during fine-tuning of AI models). In some implementations, the one or more AI model(s) of the language model router can be selected for processing routing determination based on latency requirements, resource usage constraints, task complexity, domain-specific needs, and/or any user-configured parameters. For example, a user preference and/or configuration can prioritize latency over running costs by adjusting a latency-to-cost ratio parameter. In another example, the prompt can be associated with metadata specifying a domain-specific task that aligns with a preconfigured model selection preference.

In some implementations, the language model router can select the language model according to a similarity between the prompt and one or more prompts of the plurality of example prompts and the plurality of scores of the one or more prompts. For example, a similarity-weighted algorithm can be applied to determine a weighted similarity score (e.g., similarity) by assigning different weights to prior prompts and responses based on response quality, recency, and/or contextual relevance to the current prompt. In another example, a matrix factorization router can be applied to determine latent relationships between prompts and response scores (e.g., similarity) by decomposing historical prompt-response data into lower-dimensional representations that can capture implicit associations between query patterns and model performance. In yet another example, a fine-tuned LLM-based router can be applied to determine contextual similarity (e.g., similarity) by generating embeddings of the prompt and comparing them to embeddings of historical prompts and their respective response scores using learned representations from fine-tuning. In some implementations, the language model router can select the language model according to a processing cost or cost function associated with generating the response to the prompt using the selected language model. In some implementations, the language model router can include at least one encoder model and/or non-encoder model to classify an intent of the prompt and to select the language model according to the intent.

In some implementations, the processing circuits can select the language model according to a processing cost (e.g., inference latency, memory usage, computational resource allocation, and/or any token consumption constraints). That is, the processing cost can be determined by retrieving system resource metrics, evaluating model-specific execution times, and/or analyzing prior routing data, and used to adjust model selection probabilities based on resource efficiency. For example, the processing circuits can analyze real-time memory availability and adjust routing logic to favor models with lower memory demands when system constraints are detected. In some implementations, the processing circuits can select the language model according to a cost function (e.g., weighted cost estimation, probabilistic cost modeling, runtime-based cost assessment, and/or any dynamic resource evaluation function). That is, the cost function can be applied by integrating cost-related parameters with model selection scores and used to modify ranking outputs generated by the routing model. For example, the processing circuits can apply a runtime-based cost function that penalizes high-latency models when low-latency constraints are specified in the prompt metadata.

In some implementations, a similarity score determined between the prompt and the language models can be applied to a cost algorithm (e.g., cost function implemented to adjust similarity-based rankings based on system resource constraints) to cause a generation of an output that can be compared to an initial similarity (e.g., raw similarity score, weighted similarity score, and/or adjusted similarity ranking). That is, the processing circuits can retrieve similarity scores from a similarity-based routing model and modify them based on cost constraints before performing model selection. The comparison can be used to determine which language model should process the query. For example, the processing circuits can determine an adjusted ranking by applying a cost penalty to high-latency models and preserve the original similarity-based ranking structure.

In some implementations, the processing circuits can select the language model according to a similarity between at least one vector embedding (e.g., semantic features) of the prompt and a plurality of feature embeddings (e.g., task-specific attributes, domain expertise) representing one or more functionalities (e.g., summarization, question answering, translation) of the plurality of language models. In some implementations, the processing circuits can update at least one encoder model of the language model router using a training dataset including prompt-response pairs corresponding with the plurality of example prompts and the plurality of scores of the example responses. That is, prompt, response pairs can be used to fine-tune models (e.g., cost optimization BERT, intent classification DeBERTa, matrix factorization). In some implementations, the processing circuits can update a configuration file (e.g., config.yaml. model/endpoints to route, router_type) to include information of a plurality of prompts, routing rules, and/or endpoint addresses of the plurality of language models. For example, responsive to selecting the language model the processing circuits can obtain and/or access the configuration file to determine at least one routing rule and at least one endpoint for processing the prompt by the selected language model. Additionally, the processing circuits can obtain the example responses based at least on transmitting the plurality of example prompts to one or more endpoints (e.g., perform dataset generation by interacting with different routing endpoints and the generated pairs can be saved for fine-tuning) corresponding to the plurality of language models.

The method 200, at block 220, includes providing the prompt to the selected language model to cause the selected language model to generate a response to the prompt. For example, the processing circuits can transmit the prompt to the endpoint associated with the selected language model and facilitate communication to retrieve the response. The selected language model can include a corresponding endpoint and/or otherwise accessible interface. That is, at least one endpoint of the one or more endpoints can be associated with a specific language model. For example, responsive to selecting the language model the processing circuits can transmit the prompt to a selected endpoint of the selected language model to generate the response. The response can be provided by the processing circuits to a user device of a user and/or another system for presentation and/or further processing. For example, the processing circuits can provide, reformat the response for compatibility with downstream applications, and/or annotate the response with metadata for tracking purposes.

In some implementations, while providing a prompt to the selected language model is described, it should be understood that the language model router can also be used to route prompts to other endpoint components. That is, the processing circuits can classify the prompt and route it to endpoints such as hardware accelerators (e.g., selecting a specific GPU type for processing), task-specific microservices (e.g., initiating a data processing pipeline), and/or other action-based systems (e.g., triggering predefined workflows). For example, the processing circuits can classify a prompt and route it to a specialized GPU for intensive computations or to a lightweight processor for energy-efficient tasks. In another example, the processing circuits can determine the prompt requires invoking a non-language model endpoint, such as a database query service or an API-based task executor, and route the prompt accordingly.

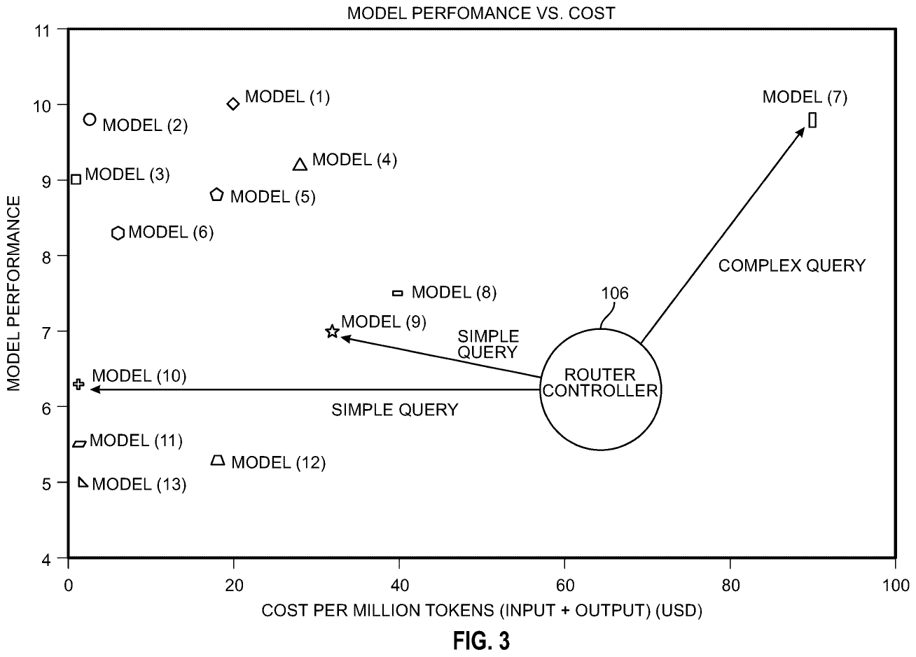

Referring now to FIG. 3, an example illustration of model performance versus cost in selecting language models for processing queries, in accordance with some implementations of the present disclosure. The router controller 106 can route queries based on multiple factors, including the complexity of the query, task-specific requirements, resource availability, latency constraints, and predefined routing policies considering cost-performance tradeoffs associated with different language models. For example, model(1) and model(2) can be selected for processing queries with lower complexity, as these models can generate responses efficiently within specified resource constraints. In another example, model(3) can be selected for queries requiring higher performance levels, where associated costs align with the task-specific requirements of the query. The router controller 106 can evaluate the query using encoder models (e.g., encoder models 108 of FIG. 1) and determine the model endpoint (e.g., model endpoint 120 of FIG. 1) based on factors such as task compatibility, resource efficiency, and/or scoring criteria derived from prior performance data. In FIG. 3, model(4) and model(5) can represent options for queries requiring intermediate levels of performance and cost considerations. The router controller 106 can use the routing pipeline to select model endpoints.

### Example Language Models

In at least some implementations, language models, such as large language models (LLMs), vision language models (VLMs), multi-modal language models (MMLMs), and/or other types of generative artificial intelligence (AI) can be implemented. Generally, the language models can process input data to perform tasks such as generating responses, classifying data, translating content, summarizing information, or performing other query-specific operations. These models can be capable of understanding, summarizing, translating, and/or otherwise generating text (e.g., natural language text, code, etc.), images, video, computer aided design (CAD) assets, OMNIVERSE and/or METAVERSE file information (e.g., in USD format, such as OpenUSD), and/or the like, based on the context provided in input prompts or queries. These language models can be considered “large,” in implementations, based on the models being trained on massive datasets and having architectures with large number of learnable network parameters (weights and biases)—such as millions or billions of parameters. The LLMs/VLMs/MMLMs/etc. can be implemented for summarizing textual data, analyzing and extracting insights from data (e.g., textual, image, video, etc.), and generating new text/image/video/etc. in user-specified styles, tones, and/or formats. The LLMs/VLMs/MMLMs/etc. of the present disclosure can be used exclusively for text processing, in implementations, whereas in other implementations, multi-modal LLMs can be implemented to accept, understand, and/or generate text and/or other types of content like images, audio, 2D and/or 3D data (e.g., in USD formats), and/or video. For example, vision language models (VLMs), or more generally multi-modal language models (MMLMs), can be implemented to accept image, video, audio, textual, 3D design (e.g., CAD), and/or other inputs data types and/or to generate or output image, video, audio, textual, 3D design, and/or other output data types.

Various types of LLMs/VLMs/MMLMs/etc. architectures can be implemented in various implementations. For example, different architectures can be implemented that use different techniques for understanding and generating outputs—such as text, audio, video, image, 2D and/or 3D design or asset data, etc. In some implementations, LLMs/VLMs/MMLMs/etc. architectures such as recurrent neural networks (RNNs) or long short-term memory networks (LSTMs) can be used, while in other implementations transformer architectures—such as those that rely on self-attention and/or cross-attention (e.g., between contextual data and textual data) mechanisms—can be used to understand and recognize relationships between words or tokens and/or contextual data (e.g., other text, video, image, design data, USD, etc.). One or more generative processing pipelines that include LLMs/VLMs/MMLMs/etc. can also include one or more diffusion block(s) (e.g., denoisers). The LLMs/VLMs/MMLMs/etc. of the present disclosure can include encoder and/or decoder block(s). For example, discriminative or encoder-only models like BERT (Bidirectional Encoder Representations from Transformers) can be implemented for tasks that involve language comprehension such as classification, sentiment analysis, question answering, and named entity recognition. As another example, generative or decoder-only models like GPT (Generative Pretrained Transformer) can be implemented for tasks that involve language and content generation such as text completion, story generation, and dialogue generation. LLMs/VLMs/MMLMs/etc. that include both encoder and decoder components like T5 (Text-to-Text Transformer) can be implemented to understand and generate content, such as for translation and summarization. These examples are not intended to be limiting, and any architecture type—including but not limited to those described herein—can be implemented depending on the particular implementation and the task(s) being performed using the LLMs/VLMs/MMLMs/etc.

In various implementations, the LLMs/VLMs/MMLMs/etc. can be trained using unsupervised learning, in which an LLMs/VLMs/MMLMs/etc. learns patterns from large amounts of unlabeled text/audio/video/image/design/USD/etc. data. Due to the extensive training, in implementations, the models cannot require task-specific or domain-specific training. LLMs/VLMs/MMLMs/etc. that have undergone extensive pre-training on vast amounts of unlabeled data can be referred to as foundation models and can be adept at a variety of tasks like question-answering, summarization, filling in missing information, translation, image/video/design/USD/data generation. Some LLMs/VLMs/MMLMs/etc. can be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some implementations, the LLMs/VLMs/MMLMs/etc. of the present disclosure can be implemented using various model alignment techniques. For example, in some implementations, guardrails can be implemented to identify improper or undesired inputs (e.g., prompts) and/or outputs of the models. In doing so, the system can use the guardrails and/or other model alignment techniques to either prevent a particular undesired input from being processed using the LLMs/VLMs/MMLMs/etc., and/or preventing the output or presentation (e.g., display, audio output, etc.) of information generating using the LLMs/VLMs/MMLMs/etc. In some implementations, one or more additional models—or layers thereof—can be implemented to identify issues with inputs and/or outputs of the models. For example, these “safeguard” models can be trained to identify inputs and/or outputs that are “safe” or otherwise okay or desired and/or that are “unsafe” or are otherwise undesired for the particular application/implementation. As a result, the LLMs/VLMs/MMLMs/etc. of the present disclosure can be less likely to output language/text/audio/video/design data/USD data/etc. that can be offensive, vulgar, improper, unsafe, out of domain, and/or otherwise undesired for the particular application/implementation.

In some implementations, the LLMs/VLMs/etc. can be configured to or capable of accessing or using one or more plug-ins, application programming interfaces (APIs), databases, data stores, repositories, etc. For example, for certain tasks or operations that the model is not ideally suited for, the model can have instructions (e.g., as a result of training, and/or based on instructions in a given prompt) to access one or more plug-ins (e.g., 3^{rd} party plugins) for help in processing the current input. In such an example, where at least part of a prompt is related to restaurants or weather, the model can access one or more restaurant or weather plug-ins (e.g., via one or more APIs) to retrieve the relevant information. As another example, where at least part of a response requires a mathematical computation, the model can access one or more math plug-ins or APIs for help in solving the problem(s), and can then use the response from the plug-in and/or API in the output from the model. This process can be repeated—e.g., recursively—for any number of iterations and using any number of plug-ins and/or APIs until a response to the input prompt can be generated that addresses each ask/question/request/process/operation/etc. As such, the model(s) can not only rely on its own knowledge from training on a large dataset(s), but also on the expertise or optimized nature of one or more external resources—such as APIs, plug-ins, and/or the like.

In some implementations, multiple language models (e.g., LLMs/VLMs/MMLMs/etc., multiple instances of the same language model, and/or multiple prompts provided to the same language model or instance of the same language model can be implemented, executed, or accessed (e.g., using one or more plug-ins, user interfaces, APIs, databases, data stores, repositories, etc.) to provide output responsive to the same query, or responsive to separate portions of a query. In at least one implementation, multiple language models e.g., language models with different architectures, language models trained on different (e.g. updated) corpuses of data can be provided with the same input query and prompt (e.g., set of constraints, conditioners, etc.). In one or more implementations, the language models can be different versions of the same foundation model. In one or more implementations, at least one language model can be instantiated as multiple agents—e.g., more than one prompt can be provided to constrain, direct, or otherwise influence a style, a content, or a character, etc., of the output provided. In one or more example, non-limiting implementations, the same language model can be asked to provide output corresponding to a different role, perspective, character, or having a different base of knowledge, etc.—as defined by a supplied prompt.

In any one of such implementations, the output of two or more (e.g., each) language models, two or more versions of at least one language model, two or more instanced agents of at least one language model, and/or two more prompts provided to at least one language model can be further processed, e.g., aggregated, compared or filtered against, or used to determine (and provide) a consensus response. In one or more implementations, the output from one language model—or version, instance, or agent—can be provided as input to another language model for further processing and/or validation. In one or more implementations, a language model can be asked to generate or otherwise obtain an output with respect to an input source material, with the output being associated with the input source material. Such an association can include, for example, the generation of a caption or portion of text that is embedded (e.g., as metadata) with an input source text or image. In one or more implementations, an output of a language model can be used to determine the validity of an input source material for further processing, or inclusion in a dataset. For example, a language model can be used to assess the presence (or absence) of a target word in a portion of text or an object in an image, with the text or image being annotated to note such presence (or lack thereof). Alternatively, the determination from the language model can be used to determine whether the source material should be included in a curated dataset, for example and without limitation.

FIG. 4A is a block diagram of an example generative language model system 400 suitable for use in implementing at least some implementations of the present disclosure. Generally, the example generative language model system 400 can process queries using one or more language models to generate outputs, route prompts to appropriate endpoints, and/or facilitate communication between user interfaces and backend models for tasks such as summarization, translation, and/or information retrieval. In the example illustrated in FIG. 4A, the generative language model system 400 includes a retrieval augmented generation (RAG) component 492, an input processor 405, a tokenizer 410, an embedding component 420, plug-ins/APIs 495, and a generative language model (LM) 430 (which can include an LLM, a VLM, a multi-modal LM, etc.).

At a high level, the input processor 405 can receive an input 401 comprising text and/or other types of input data (e.g., audio data, video data, image data, sensor data (e.g., LiDAR, RADAR, ultrasonic, etc.), 3D design data, CAD data, universal scene descriptor (USD) data—such as OpenUSD, etc.), depending on the architecture of the generative LM 430 (e.g., LLM/VLM/MMLM/etc.). In some implementations, the input 401 includes plain text in the form of one or more sentences, paragraphs, and/or documents. Additionally or alternatively, the input 401 can include numerical sequences, precomputed embeddings (e.g., word or sentence embeddings), and/or structured data (e.g., in tabular formats, JSON, or XML). In some implementations in which the generative LM 430 is capable of processing multi-modal inputs, the input 401 can combine text (or can omit text) with image data, audio data, video data, design data, USD data, and/or other types of input data, such as but not limited to those described herein. Taking raw input text as an example, the input processor 405 can prepare raw input text in various ways. For example, the input processor 405 can perform various types of text filtering to remove noise (e.g., special characters, punctuation, HTML tags, stopwords, portions of an image(s), portions of audio, etc.) from relevant textual content. In an example involving stopwords (common words that tend to carry little semantic meaning), the input processor 405 can remove stopwords to reduce noise and focus the generative LM 430 on more meaningful content. The input processor 405 can apply text normalization, for example, by converting all characters to lowercase, removing accents, and/or or handling special cases like contractions or abbreviations to ensure consistency. These are just a few examples, and other types of input processing can be applied.

In some implementations, a RAG component 492 (which can include one or more RAG models, and/or can be performed using the generative LM 430 itself) can be used to retrieve additional information to be used as part of the input 401 or prompt. RAG can be used to enhance the input to the LLM/VLM/MMLM/etc. with external knowledge, so that answers to specific questions or queries or requests are more relevant—such as in a case where specific knowledge is required. The RAG component 492 can fetch this additional information (e.g., grounding information, such as grounding text/image/video/audio/USD/CAD/etc.) from one or more external sources, which can then be fed to the LLM/VLM/MMLM/etc. along with the prompt to improve accuracy of the responses or outputs of the model.

For example, in some implementations, the input 401 can be generated using the query or input to the model (e.g., a question, a request, etc.) in addition to data retrieved using the RAG component 492. In some implementations, the input processor 405 can analyze the input 401 and communicate with the RAG component 492 (or the RAG component 492 can be part of the input processor 405, in implementations) in order to identify relevant text and/or other data to provide to the generative LM 430 as additional context or sources of information from which to identify the response, answer, or output 490, generally. For example, where the input indicates that the user is interested in a desired tire pressure for a particular make and model of vehicle, the RAG component 492 can retrieve—using a RAG model performing a vector search in an embedding space, for example—the tire pressure information or the text corresponding thereto from a digital (embedded) version of the user manual for that particular vehicle make and model. Similarly, where a user revisits a chatbot related to a particular product offering or service, the RAG component 492 can retrieve a prior stored conversation history—or at least a summary thereof—and include the prior conversation history along with the current ask/request as part of the input 401 to the generative LM 430.

The RAG component 492 can use various RAG techniques. For example, naïve RAG can be used where documents are indexed, chunked, and applied to an embedding model to generate embeddings corresponding to the chunks. A user query can also be applied to the embedding model and/or another embedding model of the RAG component 492 and the embeddings of the chunks along with the embeddings of the query can be compared to identify the most similar/related embeddings to the query, which can be supplied to the generative LM 430 to generate an output.

In some implementations, more advanced RAG techniques can be used. For example, prior to passing chunks to the embedding model, the chunks can undergo pre-retrieval processes (e.g., routing, rewriting, metadata analysis, expansion, etc.). In addition, prior to generating the final embeddings, post-retrieval processes (e.g., re-ranking, prompt compression, etc.) can be performed on the outputs of the embedding model prior to final embeddings being used as comparison to an input query.

As a further example, modular RAG techniques can be used, such as those that are similar to naïve and/or advanced RAG, but also include features such as hybrid search, recursive retrieval and query engines, StepBack approaches, sub-queries, and hypothetical document embedding.

As another example, Graph RAG can use knowledge graphs as a source of context or factual information. Graph RAG can be implemented using a graph database as a source of contextual information sent to the LLM/VLM/MMLM/etc. Rather than (or in addition to) providing the model with chunks of data extracted from larger sized documents—which can result in a lack of context, factual correctness, language accuracy, etc.—graph RAG can also provide structured entity information to the LLM/VLM/MMLM/etc. by combining the structured entity textual description with its many properties and relationships, allowing for deeper insights by the model. When implementing graph RAG, the systems and methods described herein use a graph as a content store and extract relevant chunks of documents and ask the LLM/VLM/MMLM/etc. to answer using them. The knowledge graph, in such implementations, can contain relevant textual content and metadata about the knowledge graph as well as be integrated with a vector database. In some implementations, the graph RAG can use a graph as a subject matter expert, where descriptions of concepts and entities relevant to a query/prompt can be extracted and passed to the model as semantic context. These descriptions can include relationships between the concepts. In other examples, the graph can be used as a database, where part of a query/prompt can be mapped to a graph query, the graph query can be executed, and the LLM/VLM/MMLM/etc. can summarize the results. In such an example, the graph can store relevant factual information, and a query (natural language query) to graph query tool (NL-to-Graph-query tool) and entity linking can be used. In some implementations, graph RAG (e.g., using a graph database) can be combined with standard (e.g., vector database) RAG, and/or other RAG types, to benefit from multiple approaches.

In any implementations, the RAG component 492 can implement a plugin, API, user interface, and/or other functionality to perform RAG. For example, a graph RAG plug-in can be used by the LLM/VLM/MMLM/etc. to run queries against the knowledge graph to extract relevant information for feeding to the model, and a standard or vector RAG plug-in can be used to run queries against a vector database. For example, the graph database can interact with a plug-in's REST interface such that the graph database is decoupled from the vector database and/or the embeddings models.

The tokenizer 410 can segment the (e.g., processed) text data into smaller units (tokens) for subsequent analysis and processing. The tokens can represent individual words, subwords, characters, portions of audio/video/image/etc., depending on the implementation. Word-based tokenization divides the text into individual words, treating each word as a separate token. Subword tokenization breaks down words into smaller meaningful units (e.g., prefixes, suffixes, stems), enabling the generative LM 430 to understand morphological variations and handle out-of-vocabulary words more effectively. Character-based tokenization represents each character as a separate token, enabling the generative LM 430 to process text at a fine-grained level. The choice of tokenization strategy can depend on factors such as the language being processed, the task at hand, and/or characteristics of the training dataset. As such, the tokenizer 410 can convert the (e.g., processed) text into a structured format according to tokenization schema being implemented in the particular implementation.

The embedding component 420 can use any known embedding technique to transform discrete tokens into (e.g., dense, continuous vector) representations of semantic meaning. For example, the embedding component 420 can use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 401 includes image data/video data/etc., the input processor 405 can resize the data to a standard size compatible with format of a corresponding input channel and/or can normalize pixel values to a common range (e.g., 0 to 1) to ensure a consistent representation, and the embedding component 420 can encode the image data using any known technique (e.g., using one or more convolutional neural networks (CNNs) to extract visual features). In some implementations in which the input 401 includes audio data, the input processor 405 can resample an audio file to a consistent sampling rate for uniform processing, and the embedding component 420 can use any known technique to extract and encode audio features—such as in the form of a spectrogram (e.g., a mel-spectrogram). In some implementations in which the input 401 includes video data, the input processor 405 can extract frames or apply resizing to extracted frames, and the embedding component 420 can extract features such as optical flow embeddings or video embeddings and/or can encode temporal information or sequences of frames. In some implementations in which the input 401 includes multi-modal data, the embedding component 420 can fuse representations of the different types of data (e.g., text, image, audio, USD, video, design, etc.) using techniques like early fusion (concatenation), late fusion (sequential processing), attention-based fusion (e.g., self-attention, cross-attention), etc.

The generative LM 430 and/or other components of the generative LM system 400 can use different types of neural network architectures depending on the implementation. For example, transformer-based architectures such as those used in models like GPT can be implemented, and can include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multi-modal), RNNs, LSTMs, fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, and others. As such, depending on the implementation and architecture, the embedding component 420 can apply an encoded representation of the input 401 to the generative LM 430, and the generative LM 430 can process the encoded representation of the input 401 to generate an output 490, which can include responsive text and/or other types of data.

As described herein, in some implementations, the generative LM 430 can be configured to access or use—or capable of accessing or using—plug-ins/APIs 495 (which can include one or more plug-ins, application programming interfaces (APIs), databases, data stores, repositories, etc.). For example, for certain tasks or operations that the generative LM 430 is not ideally suited for, the model can have instructions (e.g., as a result of training, and/or based on instructions in a given prompt, such as those retrieved using the RAG component 492) to access one or more plug-ins/APIs 495 (e.g., 3^{rd} party plugins) for help in processing the current input. In such an example, where at least part of a prompt is related to restaurants or weather, the model can access one or more restaurant or weather plug-ins (e.g., via one or more APIs), send at least a portion of the prompt related to the particular plug-in/API 495 to the plug-in/API 495, the plug-in/API 495 can process the information and return an answer to the generative LM 430, and the generative LM 430 can use the response to generate the output 490. This process can be repeated—e.g., recursively—for any number of iterations and using any number of plug-ins/APIs 495 until an output 490 that addresses each ask/question/request/process/operation/etc. from the input 401 can be generated. As such, the model(s) can not only rely on its own knowledge from training on a large dataset(s) and/or from data retrieved using the RAG component 492, but also on the expertise or optimized nature of one or more external resources—such as the plug-ins/APIs 495.

FIG. 4B is a block diagram of an example implementation in which the generative LM 430 includes a transformer encoder-decoder. Generally, the generative LM 430 can process prompts received from the router controller 106 of FIG. 1 to generate responses by applying its encoder-based architecture. For example, assume input text such as “Who discovered gravity” is tokenized (e.g., by the tokenizer410 of FIG. 4A) into tokens such as words, and each token is encoded (e.g., by the embedding component 420 of FIG. 4A) into a corresponding embedding (e.g., of size 512). Since these token embeddings typically do not represent the position of the token in the input sequence, any known technique can be used to add a positional encoding to each token embedding to encode the sequential relationships and context of the tokens in the input sequence. As such, the (e.g., resulting) embeddings can be applied to one or more encoder(s) 435 of the generative LM 430.

In an example implementation, the encoder(s) 435 forms an encoder stack, where each encoder includes a self-attention layer and a feedforward network. In an example transformer architecture, each token (e.g., word) flows through a separate path. As such, each encoder can accept a sequence of vectors, passing each vector through the self-attention layer, then the feedforward network, and then upwards to the next encoder in the stack. Any known self-attention technique can be used. For example, to calculate a self-attention score for each token (word), a query vector, a key vector, and a value vector can be created for each token, a self-attention score can be calculated for pairs of tokens by taking the dot product of the query vector with the corresponding key vectors, normalizing the resulting scores, multiplying by corresponding value vectors, and summing weighted value vectors. The encoder can apply multi-headed attention in which the attention mechanism is applied multiple times in parallel with different learned weight matrices. Any number of encoders can be cascaded to generate a context vector encoding the input. An attention projection layer 440 can convert the context vector into attention vectors (keys and values) for the decoder(s) 445.

In an example implementation, the decoder(s) 445 form a decoder stack, where each decoder includes a self-attention layer, an encoder-decoder self-attention layer that uses the attention vectors (keys and values) from the encoder to focus on relevant parts of the input sequence, and a feedforward network. As with the encoder(s) 435, in an example transformer architecture, each token (e.g., word) flows through a separate path in the decoder(s) 445. During a first pass, the decoder(s) 445, a classifier 450, and a generation mechanism 455 can generate a first token, and the generation mechanism 455 can apply the generated token as an input during a second pass. The process can repeat in a loop, successively generating and adding tokens (e.g., words) to the output from the preceding pass and applying the token embeddings of the composite sequence with positional encodings as an input to the decoder(s) 445 during a subsequent pass, sequentially generating one token at a time (known as auto-regression) until predicting a symbol or token that represents the end of the response. Within each decoder, the self-attention layer is typically constrained to attend only to preceding positions in the output sequence by applying a masking technique (e.g., setting future positions to negative infinity) before the softmax operation. In an example implementation, the encoder-decoder attention layer operates similarly to the (e.g., multi-headed) self-attention in the encoder(s) 435, except that it creates its queries from the layer below it and takes the keys and values (e.g., matrix) from the output of the encoder(s) 435.

As such, the decoder(s) 445 can output some decoded (e.g., vector) representation of the input being applied during a particular pass. The classifier 450 can include a multi-class classifier comprising one or more neural network layers that project the decoded (e.g., vector) representation into a corresponding dimensionality (e.g., one dimension for each supported word or token in the output vocabulary) and a softmax operation that converts logits to probabilities. As such, the generation mechanism 455 can select or sample a word or token based on a corresponding predicted probability (e.g., select the word with the highest predicted probability) and append it to the output from a previous pass, generating each word or token sequentially. The generation mechanism 455 can repeat the process, triggering successive decoder inputs and corresponding predictions until selecting or sampling a symbol or token that represents the end of the response, at which point, the generation mechanism 455 can output the generated response.

FIG. 4C is a block diagram of an example implementation in which the generative LM 430 includes a decoder-only transformer architecture. For example, the decoder(s) 460 of FIG. 4C can operate similarly as the decoder(s) 445 of FIG. 4B except each of the decoder(s) 460 of FIG. 4C omits the encoder-decoder self-attention layer (since there is no encoder in this implementation). As such, the decoder(s) 460 can form a decoder stack, where each decoder includes a self-attention layer and a feedforward network. Furthermore, instead of encoding the input sequence, a symbol or token representing the end of the input sequence (or the beginning of the output sequence) can be appended to the input sequence, and the resulting sequence (e.g., corresponding embeddings with positional encodings) can be applied to the decoder(s) 460. As with the decoder(s) 445 of FIG. 4B, each token (e.g., word) can flow through a separate path in the decoder(s) 460, and the decoder(s) 460, a classifier 465, and a generation mechanism 470 can use auto-regression to sequentially generate one token at a time until predicting a symbol or token that represents the end of the response. The classifier 465 and the generation mechanism 470 can operate similarly as the classifier 450 and the generation mechanism 455 of FIG. 4B, with the generation mechanism 470 selecting or sampling each successive output token based on a corresponding predicted probability and appending it to the output from a previous pass, generating each token sequentially until selecting or sampling a symbol or token that represents the end of the response. These and other architectures described herein are meant simply as examples, and other suitable architectures can be implemented within the scope of the present disclosure.

### Example Computing Device

FIG. 5 is a block diagram of an example computing device(s) 500 suitable for use in implementing some implementations of the present disclosure. Generally, the example computing device(s) 500 can execute operations of the router controller, perform prompt processing, interface with model endpoints, and/or manage data transmission and retrieval for query routing and response generation. Computing device 500 can include an interconnect system 502 that directly or indirectly couples the following devices: memory 504, one or more central processing units (CPUs) 506, one or more graphics processing units (GPUs) 508, a communication interface 510, input/output (I/O) ports 512, input/output components 514, a power supply 516, one or more presentation components 518 (e.g., display(s)), and one or more logic units 520. In at least one implementation, the computing device(s) 500 can comprise one or more virtual machines (VMs), and/or any of the components thereof can comprise virtual components (e.g., virtual hardware components). For non-limiting examples, one or more of the GPUs 508 can comprise one or more vGPUs, one or more of the CPUs 506 can comprise one or more vCPUs, and/or one or more of the logic units 520 can comprise one or more virtual logic units. As such, a computing device(s) 500 can include discrete components (e.g., a full GPU dedicated to the computing device 500), virtual components (e.g., a portion of a GPU dedicated to the computing device 500), or a combination thereof.

Although the various blocks of FIG. 5 are shown as connected via the interconnect system 502 with lines, this is not intended to be limiting and is for clarity only. For example, in some implementations, a presentation component 518, such as a display device, can be considered an I/O component 514 (e.g., if the display is a touch screen). As another example, the CPUs 506 and/or GPUs 508 can include memory (e.g., the memory 504 can be representative of a storage device in addition to the memory of the GPUs 508, the CPUs 506, and/or other components). As such, the computing device of FIG. 5 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 5.

The interconnect system 502 can represent one or more links or busses, such as an address bus, a data bus, a control bus, or a combination thereof. The interconnect system 502 can include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some implementations, there are direct connections between components. As an example, the CPU 506 can be directly connected to the memory 504. Further, the CPU 506 can be directly connected to the GPU 508. Where there is direct, or point-to-point connection between components, the interconnect system 502 can include a PCIe link to carry out the connection. In these examples, a PCI bus need not be included in the computing device 500.

The memory 504 can include any of a variety of computer-readable media. The computer-readable media can be any available media that can be accessed by the computing device 500. The computer-readable media can include both volatile and nonvolatile media, and removable and non-removable media. By way of example, and not limitation, the computer-readable media can comprise computer-storage media and communication media.

The computer-storage media can include both volatile and nonvolatile media and/or removable and non-removable media implemented in any method or technology for storage of information such as computer-readable instructions, data structures, program modules, and/or other data types. For example, the memory 504 can store computer-readable instructions (e.g., that represent a program(s) and/or a program element(s), such as an operating system. Computer-storage media can include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 500. As used herein, computer storage media does not comprise signals per se.

The computer storage media can embody computer-readable instructions, data structures, program modules, and/or other data types in a modulated data signal such as a carrier wave or other transport mechanism and includes any information delivery media. The term “modulated data signal” can refer to a signal that has one or more of its characteristics set or changed in such a manner as to encode information in the signal. By way of example, and not limitation, the computer storage media can include wired media such as a wired network or direct-wired connection, and wireless media such as acoustic, RF, infrared and other wireless media. Combinations of any of the above should also be included within the scope of computer-readable media.

The CPU(s) 506 can be configured to execute at least some of the computer-readable instructions to control one or more components of the computing device 500 to perform one or more of the methods and/or processes described herein. The CPU(s) 506 can each include one or more cores (e.g., one, two, four, eight, twenty-eight, seventy-two, etc.) that are capable of handling a multitude of software threads simultaneously. The CPU(s) 506 can include any type of processor, and can include different types of processors depending on the type of computing device 500 implemented (e.g., processors with fewer cores for mobile devices and processors with more cores for servers). For example, depending on the type of computing device 500, the processor can be an Advanced RISC Machines (ARM) processor implemented using Reduced Instruction Set Computing (RISC) or an x86 processor implemented using Complex Instruction Set Computing (CISC). The computing device 500 can include one or more CPUs 506 in addition to one or more microprocessors or supplementary co-processors, such as math co-processors.

In addition to or alternatively from the CPU(s) 506, the GPU(s) 508 can be configured to execute at least some of the computer-readable instructions to control one or more components of the computing device 500 to perform one or more of the methods and/or processes described herein. One or more of the GPU(s) 508 can be an integrated GPU (e.g., with one or more of the CPU(s) 506 and/or one or more of the GPU(s) 508 can be a discrete GPU. In implementations, one or more of the GPU(s) 508 can be a coprocessor of one or more of the CPU(s) 506. The GPU(s) 508 can be used by the computing device 500 to render graphics (e.g., 3D graphics) or perform general purpose computations. For example, the GPU(s) 508 can be used for General-Purpose computing on GPUs (GPGPU). The GPU(s) 508 can include hundreds or thousands of cores that are capable of handling hundreds or thousands of software threads simultaneously. The GPU(s) 508 can generate pixel data for output images in response to rendering commands (e.g., rendering commands from the CPU(s) 506 received via a host interface). The GPU(s) 508 can include graphics memory, such as display memory, for storing pixel data or any other suitable data, such as GPGPU data. The display memory can be included as part of the memory 504. The GPU(s) 508 can include two or more GPUs operating in parallel (e.g., via a link). The link can directly connect the GPUs (e.g., using NVLINK) or can connect the GPUs through a switch (e.g., using NVSwitch). When combined together, each GPU 508 can generate pixel data or GPGPU data for different portions of an output or for different outputs (e.g., a first GPU for a first image and a second GPU for a second image). Each GPU can include its own memory, or can share memory with other GPUs.

In addition to or alternatively from the CPU(s) 506 and/or the GPU(s) 508, the logic unit(s) 520 can be configured to execute at least some of the computer-readable instructions to control one or more components of the computing device 500 to perform one or more of the methods and/or processes described herein. In implementations, the CPU(s) 506, the GPU(s) 508, and/or the logic unit(s) 520 can discretely or jointly perform any combination of the methods, processes and/or portions thereof. One or more of the logic units 520 can be part of and/or integrated in one or more of the CPU(s) 506 and/or the GPU(s) 508 and/or one or more of the logic units 520 can be discrete components or otherwise external to the CPU(s) 506 and/or the GPU(s) 508. In implementations, one or more of the logic units 520 can be a coprocessor of one or more of the CPU(s) 506 and/or one or more of the GPU(s) 508.

Examples of the logic unit(s) 520 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Programmable Vision Accelerator (PVAs)—which can include one or more direct memory access (DMA) systems, one or more vision or vector processing units (VPUs), one or more pixel processing engines (PPEs)—e.g., including a 2D array of processing elements that each communicate north, south, east, and west with one or more other processing elements in the array, one or more decoupled accelerators or units (e.g., decoupled lookup table (DLUT) accelerators or units), etc., Vision Processing Units (VPUs), Optical Flow Accelerators (OFAs), Field Programmable Gate Arrays (FPGAs), Neuromorphic Chips, Quantum Processing Units (QPUs), Associative Process Units (APUs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 510 can include one or more receivers, transmitters, and/or transceivers that allow the computing device 500 to communicate with other computing devices via an electronic communication network, included wired and/or wireless communications. The communication interface 510 can include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more implementations, logic unit(s) 520 and/or communication interface 510 can include one or more data processing units (DPUs) to transmit data received over a network and/or through interconnect system 502 directly to (e.g., a memory of) one or more GPU(s) 508.

The I/O ports 512 can allow the computing device 500 to be logically coupled to other devices including the I/O components 514, the presentation component(s) 518, and/or other components, some of which can be built in to (e.g., integrated in) the computing device 500. Illustrative I/O components 514 include a microphone, mouse, keyboard, joystick, game pad, game controller, satellite dish, scanner, printer, wireless device, etc. The I/O components 514 can provide a natural user interface (NUI) that processes air gestures, voice, or other physiological inputs generated by a user. In some instances, inputs can be transmitted to an appropriate network element for further processing. An NUI can implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 500. The computing device 500 can be include depth cameras, such as stereoscopic camera systems, infrared camera systems, RGB camera systems, touchscreen technology, and combinations of these, for gesture detection and recognition. Additionally, the computing device 500 can include accelerometers or gyroscopes (e.g., as part of an inertia measurement unit (IMU)) that allow detection of motion. In some examples, the output of the accelerometers or gyroscopes can be used by the computing device 500 to render immersive augmented reality or virtual reality.

The power supply 516 can include a hard-wired power supply, a battery power supply, or a combination thereof. The power supply 516 can provide power to the computing device 500 to allow the components of the computing device 500 to operate.

The presentation component(s) 518 can include a display (e.g., a monitor, a touch screen, a television screen, a heads-up-display (HUD), other display types, or a combination thereof), speakers, and/or other presentation components. The presentation component(s) 518 can receive data from other components (e.g., the GPU(s) 508, the CPU(s) 506, DPUs, etc.), and output the data (e.g., as an image, video, sound, etc.).

### Example Data Center

FIG. 6 illustrates an example data center 600 that can be used in at least one implementations of the present disclosure. Generally, the example data center 600 can provide computational resources, such as processing circuitry, memory, and storage, to support the operations of the router controller 106 and the execution of language models 121 of FIG. 1. The data center 600 can include a data center infrastructure layer 610, a framework layer 620, a software layer 630, and/or an application layer 640.

As shown in FIG. 6, the data center infrastructure layer 610 can include a resource orchestrator 612, grouped computing resources 614, and node computing resources (“node C.R.s”) 616(1)-616(N), where “N” represents any whole, positive integer. In at least one implementation, node C.R.s 616(1)-616(N) can include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some implementations, one or more node C.R.s from among node C.R.s 616(1)-616(N) can correspond to a server having one or more of the above-mentioned computing resources. In addition, in some implementations, the node C.R.s 616(1)-6161(N) can include one or more virtual components, such as vGPUs, vCPUs, and/or the like, and/or one or more of the node C.R.s 616(1)-616(N) can correspond to a virtual machine (VM).

In at least one implementation, grouped computing resources 614 can include separate groupings of node C.R.s 616 housed within one or more racks (not shown), or many racks housed in data centers at various geographical locations (also not shown). Separate groupings of node C.R.s 616 within grouped computing resources 614 can include grouped compute, network, memory or storage resources that can be configured or allocated to support one or more workloads. In at least one implementation, several node C.R.s 616 including CPUs, GPUs, DPUs, and/or other processors can be grouped within one or more racks to provide compute resources to support one or more workloads. The one or more racks can also include any number of power modules, cooling modules, and/or network switches, in any combination.

The resource orchestrator 612 can configure or otherwise control one or more node C.R. s 616(1)-616(N) and/or grouped computing resources 614. In at least one implementation, resource orchestrator 612 can include a software design infrastructure (SDI) management entity for the data center 600. The resource orchestrator 612 can include hardware, software, or some combination thereof.

In at least one implementation, as shown in FIG. 6, framework layer 620 can include a job scheduler 628, a configuration manager 634, a resource manager 636, and/or a distributed file system 638. The framework layer 620 can include a framework to support software 632 of software layer 630 and/or one or more application(s) 642 of application layer 640. The software 632 or application(s) 642 can respectively include web-based service software or applications, such as those provided by Amazon Web Services, Google Cloud and Microsoft Azure. The framework layer 620 can be, but is not limited to, a type of free and open-source software web application framework such as Apache Spark™ (hereinafter “Spark”) that can use distributed file system 638 for large-scale data processing (e.g., “big data”). In at least one implementation, job scheduler 628 can include a Spark driver to facilitate scheduling of workloads supported by various layers of data center 600. The configuration manager 634 can be capable of configuring different layers such as software layer 630 and framework layer 620 including Spark and distributed file system 638 for supporting large-scale data processing. The resource manager 636 can be capable of managing clustered or grouped computing resources mapped to or allocated for support of distributed file system 638 and job scheduler 628. In at least one implementation, clustered or grouped computing resources can include grouped computing resource 614 at data center infrastructure layer 610. The resource manager 636 can coordinate with resource orchestrator 612 to manage these mapped or allocated computing resources.

In at least one implementation, software 632 included in software layer 630 can include software used by at least portions of node C.R.s 616(1)-616(N), grouped computing resources 614, and/or distributed file system 638 of framework layer 620. One or more types of software can include, but are not limited to, Internet web page search software, e-mail virus scan software, database software, and streaming video content software.

In at least one implementation, application(s) 642 included in application layer 640 can include one or more types of applications used by at least portions of node C.R.s 616(1)-616(N), grouped computing resources 614, and/or distributed file system 638 of framework layer 620. One or more types of applications can include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more implementations.

In at least one implementation, any of configuration manager 634, resource manager 636, and resource orchestrator 612 can implement any number and type of self-modifying actions based on any amount and type of data acquired in any technically feasible fashion. Self-modifying actions can relieve a data center operator of data center 600 from making possibly bad configuration decisions and possibly avoiding underutilized and/or poor performing portions of a data center.

The data center 600 can include tools, services, software or other resources to train one or more machine learning models or predict or infer information using one or more machine learning models according to one or more implementations described herein. For example, a machine learning model(s) can be trained by calculating weight parameters according to a neural network architecture using software and/or computing resources described above with respect to the data center 600. In at least one implementation, trained or deployed machine learning models corresponding to one or more neural networks can be used to infer or predict information using resources described above with respect to the data center 600 by using weight parameters calculated through one or more training techniques, such as but not limited to those described herein.

In at least one implementation, the data center 600 can use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above can be configured as a service to allow users to train or performing inferencing of information, such as image recognition, speech recognition, or other artificial intelligence services.

### Example Network Environments

Network environments suitable for use in implementing implementations of the disclosure can include one or more client devices, servers, network attached storage (NAS), other backend devices, and/or other device types. The client devices, servers, and/or other device types (e.g., each device) can be implemented on one or more instances of the computing device(s) 500 of FIG. 5—e.g., each device can include similar components, features, and/or functionality of the computing device(s) 500. In addition, where backend devices (e.g., servers, NAS, etc.) are implemented, the backend devices can be included as part of a data center 600, an example of which is described in more detail herein with respect to FIG. 6.

Components of a network environment can communicate with each other via a network(s), which can be wired, wireless, or both. The network can include multiple networks, or a network of networks. By way of example, the network can include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) can provide wireless connectivity.

Compatible network environments can include one or more peer-to-peer network environments—in which case a server cannot be included in a network environment—and one or more client-server network environments—in which case one or more servers can be included in a network environment. In peer-to-peer network environments, functionality described herein with respect to a server(s) can be implemented on any number of client devices.

In at least one implementation, a network environment can include one or more cloud-based network environments, a distributed computing environment, a combination thereof, etc. A cloud-based network environment can include a framework layer, a job scheduler, a resource manager, and a distributed file system implemented on one or more of servers, which can include one or more core network servers and/or edge servers. A framework layer can include a framework to support software of a software layer and/or one or more application(s) of an application layer. The software or application(s) can respectively include web-based service software or applications. In implementations, one or more of the client devices can use the web-based service software or applications (e.g., by accessing the service software and/or applications via one or more application programming interfaces (APIs)). The framework layer can be, but is not limited to, a type of free and open-source software web application framework such as that can use a distributed file system for large-scale data processing (e.g., “big data”).

A cloud-based network environment can provide cloud computing and/or cloud storage that carries out any combination of computing and/or data storage functions described herein (or one or more portions thereof). Any of these various functions can be distributed over multiple locations from central or core servers (e.g., of one or more data centers that can be distributed across a state, a region, a country, the globe, etc.). If a connection to a user (e.g., a client device) is relatively close to an edge server(s), a core server(s) can designate at least a portion of the functionality to the edge server(s). A cloud-based network environment can be private (e.g., limited to a single organization), can be public (e.g., available to many organizations), and/or a combination thereof (e.g., a hybrid cloud environment).

The client device(s) can include at least some of the components, features, and functionality of the example computing device(s) 500 described herein with respect to FIG. 5. By way of example and not limitation, a client device can be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure can be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure can be practiced in a variety of system configurations, including hand-held devices, consumer electronics, general-purpose computers, more specialty computing devices, etc. The disclosure can also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” can include only element A, only element B, only element C, element A and element B, element A and element C, element B and element C, or elements A, B, and C. In addition, “at least one of element A or element B” can include at least one of element A, at least one of element B, or at least one of element A and at least one of element B. Further, “at least one of element A and element B” can include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” can be used herein to connote different elements of methods employed, the terms should not be interpreted as implying any particular order among or between various steps herein disclosed unless and except when the order of individual steps is explicitly described.

What is claimed is:

1. One or more processors comprising processing circuitry to:
provide a prompt to a language model router to cause the language model router to select a language model from a plurality of language models, the language model router configured based at least on a plurality of example prompts and a plurality of scores of example responses generated by the plurality of language models for the plurality of example prompts; and
provide the prompt to the selected language model to cause the selected language model to generate a response to the prompt.

2. The one or more processors of claim 1, wherein the processing circuitry is to select the language model router from a plurality of machine learning (ML) models having varied structures.

3. The one or more processors of claim 1, wherein the processing circuitry is to generate the plurality of scores by providing the plurality of example prompts and plurality of example responses to a language model separate from the plurality of language models.

4. The one or more processors of claim 1, wherein the language model router is to select the language model according to a similarity between the prompt and one or more prompts of the plurality of example prompts and the plurality of scores of the one or more prompts.

5. The one or more processors of claim 1, wherein the processing circuitry is to select the language model according to a processing cost or cost function associated with generating the response to the prompt using the selected language model.

6. The one or more processors of claim 1, wherein the language model router comprises at least one encoder model to classify an intent of the prompt and to select the language model according to the intent.

7. The one or more processors of claim 1, wherein the processing circuitry is to select the language model according to a similarity between at least one vector embedding of the prompt and a plurality of feature embeddings representing one or more functionalities of the plurality of language models.

8. The one or more processors of claim 1, wherein the processing circuitry is to update at least one encoder model of the language model router using a training dataset comprising prompt-response pairs corresponding with the plurality of example prompts and the plurality of scores of the example responses.

9. The one or more processors of claim 1, wherein the processing circuitry is to update a configuration file to comprise information of a plurality of prompts, routing rules, and endpoint addresses of the plurality of language models, and wherein responsive to selecting the language model the processing circuitry is to obtain or access the configuration file to determine at least one routing rule and at least one endpoint for processing the prompt by the selected language model.

10. The one or more processors of claim 1, wherein the processing circuitry is to obtain the example responses based at least on transmitting the plurality of example prompts to one or more endpoints corresponding to the plurality of language models, and wherein at least one endpoint of the one or more endpoints is associated with a specific language model, and wherein responsive to selecting the language model the processing circuitry is to transmit the prompt to a selected endpoint of the selected language model to generate the response.

11. The one or more processors of claim 1, wherein the one or more processors are comprised in at least one of:
a system for performing conversational AI operations;
a system for implementing one or more graphics processing units (GPUs);
a system implementing one or more multi-model language models;
a system implementing one or more large language models (LLMs);
a system implementing one or more small language models (SLMs);
a system implementing one or more vision language models (VLMs);
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for generating synthetic data;
a system for generating synthetic data using AI;
a system incorporating one or more virtual machines (VMs);
a system implemented at least partially in a data center; or
a system implemented at least partially using cloud computing resources.

12. A system, comprising:
one or more processors to:
receive a query;
apply the query as input to a language model router to cause the language model router to select a language model from a plurality of language models, the language model router configured based at least on a plurality of example queries and a plurality of scores of example responses generated by the plurality of language models for the plurality of example queries; and
provide the query to the selected language model to cause the selected language model to generate a response to the query.

13. The system of claim 12, wherein the one or more processors are to select the language model router from a plurality of machine learning (ML) models having varied structures.

14. The system of claim 12, wherein the one or more processors are to generate the plurality of scores by providing the plurality of example queries and plurality of example responses to a language model separate from the plurality of language models.

15. The system of claim 12, wherein the language model router is to select the language model according to a similarity between the query and one or more queries of the plurality of example queries and the plurality of scores of the one or more queries.

16. The system of claim 12, wherein the one or more processors are to select the language model according to a processing cost or cost function associated with generating the response to the query using the selected language model.

17. The system of claim 12, wherein the language model router comprises at least one encoder model to classify an intent of the query and to select the language model according to the intent.

18. The system of claim 12, wherein the one or more processors are to select the language model according to a similarity between at least one vector embedding of the query and a plurality of feature embeddings representing one or more functionalities of the plurality of language models.

19. The system of claim 12, wherein the one or more processors are to update at least one encoder model or non-encoder model of the language model router using a training dataset comprising query-response pairs corresponding with the plurality of example queries and the plurality of scores of the example responses.

20. A method, comprising:
providing a prompt to a language model router to cause the language model router to select a language model from a plurality of language models, the language model router configured based at least on a plurality of example prompts and a plurality of scores of example responses generated by the plurality of language models for the plurality of example prompts; and
providing the prompt to the selected language model to cause the selected language model to generate a response to the prompt.
